(19) United States
(12) Patent Application Publication
(10) Pub. No.: US 2013/0174350 A1
(43) Pub. Date: Jul. 11, 2013

(54) MATTRESS ASSEMBLIES AND METHODS EMPLOYING CLOTH MEMBER(S) THERMALLY BONDED TO FOAM SIDE SUPPORT MEMBER(S) TO FORM MATTRESS ENCASEMENTS

(71) Applicants: Michael Allman, Wilson, NC (US); Christopher Dean Page, Nashville, NC (US); Julian Thomas Young, Zebulon, NC (US); Mark Stearley, Cary, NC (US); Ivan Sobran, Raleigh, NC (US)

(72) Inventors: Michael Allman, Wilson, NC (US); Christopher Dean Page, Nashville, NC (US); Julian Thomas Young, Zebulon, NC (US); Mark Stearley, Cary, NC (US); Ivan Sobran, Raleigh, NC (US)

(21) Appl. No.: 13/738,391

(22) Filed: Jan. 10, 2013

Related U.S. Application Data
(60) Provisional application No. 61/585,021, filed on Jan. 10, 2012.
(60) Provisional application No. 61/620,649, filed on Apr. 5, 2012.

(51) Int. Cl. A47C 27/00; B68G 7/12

(52) U.S. Cl. CPC A47C 27/00; B68G 7/12
USPC 5/740; 156/60; 156/292; 156/73.1

(57) ABSTRACT

Mattress assemblies and methods employing foam side support members and cloth members to enclose mattress cores are disclosed. A mattress may include a mattress assembly enclosing a mattress core. The foam side supports of the mattress assembly may be disposed adjacent to a periphery portion of the mattress core to provide additional support, for example, when a user mounts and dismounts from the mattress. The side support members may be thermally bonded to the cloth members to secure the side supports adjacent the periphery portion of the mattress core. In this manner, the side support members may be precisely positioned relative to the mattress core without the need for adhesives or expensive manufacturing equipment to thermally weld the side support members directly to a foam base.

### PRIORITY APPLICATIONS

The present application claims priority to U.S. Provisional Patent Application Ser. No. 61/585,021 filed on Jan. 10, 2012, entitled “MATTRESS ASSEMBLIES AND METHODS EMPLOYING FOAM SIDE SUPPORT MEMBERS WITH ATTACHMENT MEMBERS,” which is hereby incorporated herein by reference in its entirety.

The present application also claims priority to U.S. Provisional Patent Application Ser. No. 61/620,649 filed on Apr. 5, 2012, entitled “MATTRESS ASSEMBLIES AND METHODS EMPLOYING FOAM SIDE SUPPORT MEMBERS WITH ATTACHMENT MEMBERS,” which is hereby incorporated herein by reference in its entirety

### FIELD OF THE DISCLOSURE

The field of the disclosure relates generally to mattress assemblies, mattresses, and related methods providing support, including edge-support members, which may be employed in bedding and seating applications.

### BACKGROUND

Innerspring assemblies are a type of mattress core utilized for mattresses or seating structures and may be composed of spring coils attached together in a matrix or array. An example of such an innerspring assembly (“innerspring”) is illustrated by an innerspring 12 depicted in FIG. 1A and provided as part of a mattress 10-1. The innerspring 12 is comprised of conventional coils 14 arranged in an interconnected matrix to form a flexible core and support surfaces of the mattress 10-1. Adjacent coils 14 are secured to one another by lower interconnection helical wires 16 and upper interconnection helical wires 18. At a perimeter 20 of the innerspring 12, innerspring coils 14 are also connected to one another by upper and lower border wires 22, 24. Upper and lower border wires 22, 24 are attached to upper and lower end turns of the coils 14 to create a frame 26 for the innerspring 12. The upper and lower border wires 22, 24 may provide firmness for edge support on the perimeter 20 of the innerspring 12 where an individual user may disproportionally place weight on the innerspring 12, such as during mounting onto and dismounting from the mattress 10-1. The mattress 10-1 may be disposed on top of a base 28 to provide base support.

With reference to the mattress 10-1 in FIG. 1A, with regard to an edge 30 of the innerspring 12, there are some general considerations regarding construction and manufacture. In normal use, the edge 30 is subjected to greater weight in the form of compression forces than an interior 32 of the innerspring 12 due to the common practice of sitting on the edge 30 of the mattress 10-1. The coils 14 located proximate to the edge 30 of the innerspring 12 are subjected to concentrated weight (loads) as opposed to coils 14 located in the interior 32. To provide further perimeter structure and edge-support for the innerspring 12, an edge-support member 34 may be disposed around the coils 14 proximate to the edge 30 of the innerspring 12 between the base 28 and the upper and the lower border wires 22, 24. The edge-support member 34 may be extruded from polymer foam, for example. One or more padding material layer 36 may be disposed on top of the innerspring 12, and then upholstery 38 (“ticking”) is placed around the padding material layer(s) 36, innerspring 12, the edge-support member 34, and base 28 to form the mattress 10-1 in its fully assembled state. This mattress structure in FIG. 1A may also be provided for other types of innersprings, including pocketed coils.

The dimensions of the edge-support member 34 must be manufactured to be compatible with the size of the innerspring 12. For example, a length of the edge-support member 34 must be properly sized to extend along the edge 30 of the innerspring 12 without extending beyond a corner 40 such that the edge-support member 34 can be properly encased within the upholstery 38, as shown in FIG. 1A. Further, the edge-support member 34 should be sufficiently engaged with the innerspring 12 to provide stability and a uniform sleep surface for the mattress 10-1 between the edge 30 and the interior 32.

FIGS. 1B and 1C depict a side-view and top view respectively of a mattress 10-2 which is a different embodiment of mattress 10-1 of FIG. 1A having a more minimalist structure above the edge-support member 34. In this regard, the edge-support member 34 is thermally bonded or welded to the base 28 by at least one weld 42 which creates a unitized foam structure. Further, projections 44 may extend from an interior side 46 of the edge-support member 34 to be positioned between the innerspring coils 14 of the innerspring 12. Frictional engagements of the projections 44 with components of the innerspring 12 serve to hold edge-support member 34 in a desired vertical location, and closely adjacent to the innerspring 12.

When attached, the base 28 and the edge-support member 34 occupy more volume than when unattached due to the non-compact geometry created during attachment. Non-compact geometries are more expensive to transport and warehouse and thus create inefficiency. This inefficiency can make it more expensive to attach the base 28 and the edge-support member 34 together at a facility where the base 28 and the edge-support member 34 are manufactured rather than later at a second facility where final assembly with other mattress assembly components occurs. Thus, it may be desired to provide a mattress assembly utilizing edge support members that may be more efficiently transported, stored, and assembled as part of a mattress.

Conventional adhesives may be used to directly attach the edge-support member 34 with the base 28 and often produce attachments that are resistant to failure. However, new attachments types and mattress assemblies are needed to reliably secure edge-support members 34 to the periphery of a mattress core compatible with efficient processes to manufacture mattresses.

### SUMMARY OF THE DETAILED DESCRIPTION

Mattress assemblies and methods employing cloth member(s) thermally bonded to foam side support member(s) to form mattress encasements are disclosed. The foam side support members of the mattress assembly may be disposed adjacent to a periphery portion of a mattress core to provide additional support, for example, when a user mounts and dismounts from the mattress. A mattress assembly forms an encasement around the mattress core so that the side supports are secured precisely adjacent the periphery portion of the mattress core and the mattress core is able to support a weight of a user. The side support members are thermally bonded to cloth members to secure the side supports adjacent the periphery portion of the mattress core. The cloth members may include fibers which are compatible with being thermally bonded to foam side support members. In this manner, the side support members may be precisely positioned relative to the mattress core without the need for adhesives.

In this regard in one embodiment, a mattress assembly is provided. The mattress assembly may include a foam base having a top side and a bottom side. The foam base may be configured to support a mattress core disposed adjacent to the top side of the foam base. The mattress assembly may also include at least one foam side support member configured to be disposed adjacent a periphery portion of the mattress core to provide side support for the mattress core supported by the foam base. The at least one foam side support member may have a first surface facing away from the foam base and a second surface facing the foam base. The mattress assembly may also include at least one cloth member having a first side thermally bonded to a peripheral portion of the top side of the foam base and a second side thermally bonded to the second surface of the at least one side support member, to secure the at least one foam side support member with the periphery portion of the mattress core. In this manner, the at least one foam side support member may be securely positioned relative to the mattress core.

In another embodiment, a mattress assembly to form a mattress encasement is disclosed. The mattress core may include a pair of foam side supports including a first side support member and a second side support member. The pair of side support members may be configured to be disposed adjacent a periphery portion of the mattress core and at opposite sides of the mattress core to provide side support for the mattress core. Each of the pair of the side support members may have a first surface and a second surface opposite the first surface. The mattress assembly may also include at least one cloth member having a first side thermally bonded to the first foam side support member and may have a second side thermally bonded to the second foam side support member. The mattress assembly may also include a second pair of foam side support members including a third side support member and a fourth side support member. The second pair of side support members may be configured to be disposed adjacent the periphery portion of the mattress core and at opposite sides of the mattress core to provide side support for the mattress core. Each of the second pair of the foam side support members may have a first surface and a second surface opposite the first surface. The mattress assembly may also include at least one second cloth member having a first side thermally bonded to the third foam side support member and a second side of the at least one second cloth member thermally bonded to the fourth foam side support member. The pair of foam side support members and the second pair of foam side support members may be collectively configured to engage with each other to enclose the mattress core. In this manner, the pair of foam side support members and the second pair of foam side support members may be efficiently assembled and positioned relative to the mattress core as part of a final assembly of a mattress.

In another embodiment, a mattress assembly to form a mattress encasement is disclosed. The mattress assembly may include a pair of foam side support members comprising a first side support member and a second side support member. The pair of side support members may be configured to be disposed adjacent a periphery portion of the mattress core and at opposite sides of the mattress core to provide side support for the mattress core. The first foam side support member may comprise adjacent first segments. The second foam side support member may comprise adjacent second segments. The mattress assembly may also include at least one cloth member having a first side thermally bonded to the first foam side support member and having a second side thermally bonded to the second foam side support member. The mattress assembly may also include at least one segment-connecting cloth member. Each of the at least one segment-connecting cloth member may have a first side thermally bonded to a respective one of the adjacent first segments of the first foam side support member and may have a second side thermally bonded to a respective one of the adjacent second segments of the second foam side support member. The at least one segment-connecting cloth member may be configured to be on an opposite side of the mattress core than the at least one cloth member. The adjacent first segments and the adjacent second segments may be configured for motion isolation. In this manner, motion energy from one portion of the pair of foam side support members may be isolated from another portion of the pair of foam side support members.

In another embodiment, a method for assembling a mattress encasement is disclosed. The method may include providing a foam base configured to support a weight of a user transmitted through a mattress core. The method may also include providing at least one foam side support member configured to be disposed along a periphery portion of the mattress core. The method may include providing at least one cloth member configured to be attached to the at least one foam side support member and the foam base. In this manner, the at least one side support member may be efficiently positioned relative to the mattress core.

The aforementioned mattress assemblies may be compatible with various types of mattress cores, for example, innerspring coil mattress cores, pocketed coil cores, or air bladder mattress cores having varying widths and lengths forming the mattress core perimeter. Furthermore, the side support members may be pivoted with respect to the foam base for more compact storage and easier transportation.

### BRIEF DESCRIPTION OF THE DRAWINGS

FIG. 1A is a perspective partial cutaway view of a mattress in the prior art including a foam side support member;

FIGS. 1B and 1C are side and top views, respectively, of a second embodiment of the mattress of FIG. 1A in the prior art including protrusions;

FIG. 2A is a top perspective view of an exemplary mattress assembly including at least one foam side support member, a foam base, and a mattress core;

FIGS. 2B and 2C are side sectional views along a width and a length respectively of the mattress assembly of FIG. 2A to illustrate at least one cloth member attaching a foam base to the at least one side support member to form a mattress enclosure;

FIG. 2D is an exploded side view of the side sectional view of the mattress assembly in FIG. 2B;

FIG. 2E is a close-up side view of the at least one cloth member of FIG. 2D used to attach the at least one side support member to a foam base, illustrating fibers within the at least one cloth member;

FIG. 2F is a close-up top view of the at least one cloth member of FIG. 2E illustrating fibers arranged without being woven;

FIG. 2G is a close-up view of an exemplary fiber of at least one cloth member of FIG. 2F illustrating a width of the fiber;

FIG. 2H is a close-up cross-sectional view of the fiber of FIG. 2G illustrating a composition of the fiber;

FIG. 2I is a close-up top view of an alternative exemplary cloth member illustrating woven fibers;

FIG. 3 is an exemplary method of assembling the mattress assembly of FIG. 2A;

FIGS. 4A through 4I are side sectional views of assembling a mattress assembly consistent with the exemplary method of FIG. 3;

FIGS. 5A and 5B are a perspective view and a perspective exploded view of the foam side support member of FIG. 2A attached to the at least one cloth member and at least one third cloth member, and the one of the at least one cloth member is also attached to the foam base;

FIGS. 5C and 5D are side sectional views along the width and the length respectively of the mattress assembly of FIG. 2A depicting an interior space without the mattress core;

FIGS. 5E and 5F are side sectional views along a width and a length respectively of the mattress assembly of FIGS. 5C and 5D after the at least one side support members are pivoted with respect to the foam base to reduce a height of the mattress assembly from H(1) to H(2) to enable easier shipment or compact storage;

FIG. 6A is a side view of another embodiment of a mattress assembly with at least one foam side support member abutting against a foam base and at least one cloth member attached to both the at least one foam side support member and the foam base;

FIG. 6B is a side view of another embodiment of a mattress assembly with at least one cloth member attached to two sides of each at least one foam side support member and the foam base illustrating the at least one cloth disposed between the at least one side support and a foam core to reduce noise during use by reducing friction between the at least one side support and the foam core;

FIGS. 7A through 7E are a top perspective view, a top perspective exploded view, a side left view, a side inner view, and a top view, respectively, of another embodiment of the mattress assembly of FIGS. 5A and 5B wherein a second cloth member is attached to the foam side support member and an engagement member;

FIGS. 8A and 8B illustrate top perspective views of another exemplary mattress assembly including at least one side support member attached to an apexed base employing at least one cloth member to secure the side support member to the base and an additional cloth member to secure the side support member to a mattress core disposed on the base;

FIG. 9A illustrates a perspective side view of another exemplary mattress assembly including at least one side support member and a base to form a mattress encasement, and an innerspring disposed on the base in the mattress encasement, wherein the side support member(s) is secured to the base with a cloth member, and wherein protrusions disposed in the side support member(s) engage with the innerspring to secure the side support member(s) about the innerspring;

FIG. 9B is a close-up view of the side support member in FIG. 9A lowered about the hinge provided by the cloth-shaped member to be disposed planar or substantially planar to the innerspring;

FIGS. 10A and 10B are an exploded top perspective view and a top perspective view of another embodiment of a mattress assembly with a pair of foam side support members attached to at least one cloth member and a second pair of side support members attached to at least one second cloth member configured to abut against the at least one cloth member, and at least a third cloth attached to the pair of foam side support members to partially enclose an interior space configured to contain a mattress core;

FIGS. 11A and 11B are an exploded top perspective view and a top perspective view of another embodiment of a mattress assembly with a pair of foam side support members attached to at least one cloth member and a second pair of side support members attached to at least one second cloth member, the at least one second cloth member configured to be disposed on a side of the mattress core opposite that of the at least one cloth member, and the second pair of foam side support members are configured to be disposed between the pair of foam support members to partially enclose an interior space configured to contain a mattress core;

FIGS. 12A and 12B are an exploded top perspective view and a top perspective view of another embodiment of a mattress assembly with a pair of foam side support members attached to at least one cloth member and a second pair of side support members attached to at least one second cloth member configured to be disposed on opposite sides of the mattress core, and the second pair of foam side support members are configured to abut against the pair of foam support members to partially enclose an interior space configured to contain a mattress core;

FIGS. 13A and 13B are a top perspective view and a side view of another embodiment of a mattress assembly with a pair of foam side support members attached to at least one cloth member and a second pair of side support members attached to at least one second cloth member, the second pair of foam side support members configured to be disposed between the pair of foam side support members to partially enclose an interior space configured to contain a mattress core;

FIGS. 13C through 13F are a side views of the mattress assembly of FIG. 13A where the pair of foam side supports and the second pair of foam side supports are progressively disengaged to illustrate how the mattress assembly of FIG. 13A may be arranged to form an aligned stack in a compact configuration;

FIGS. 14A through 14C are an exploded top perspective view, a side view, and a bottom view, respectively, of another embodiment of a mattress assembly including a pair of foam side support members having living hinges for angular articulation, illustrating at least one cloth being attached to the pair of foam side support members to restrict the angular articulation;

FIGS. 14D and 14E are close-up side views of the living hinges of the mattress assembly of FIG. 14A illustrating the living hinges at various degrees of the angular articulation;

FIGS. 15A and 15B are a side view and a close-up side view of another embodiment of a hinge of a mattress assembly illustrating at least another cloth member attached to the pair of foam side supports and the another cloth member being utilized as a pivot of the hinge;

FIGS. 16A through 16C are a top perspective exploded view, a top perspective view, and a side view, respectively, of another embodiment of a mattress assembly with a pair of foam side support members partially cut into segments and attached with at least one cloth strip to form an enclosure for a mattress core to illustrate an approach to facilitate motion isolation; and

FIGS. 17A through 17C are a top perspective exploded view, a top perspective view, and a side view, respectively, of another embodiment of a mattress assembly with a pair of foam side support members comprised of a plurality of segments of different materials and attached with at least one cloth strip to form an enclosure for a mattress core to illustrate another approach to facilitate motion isolation.

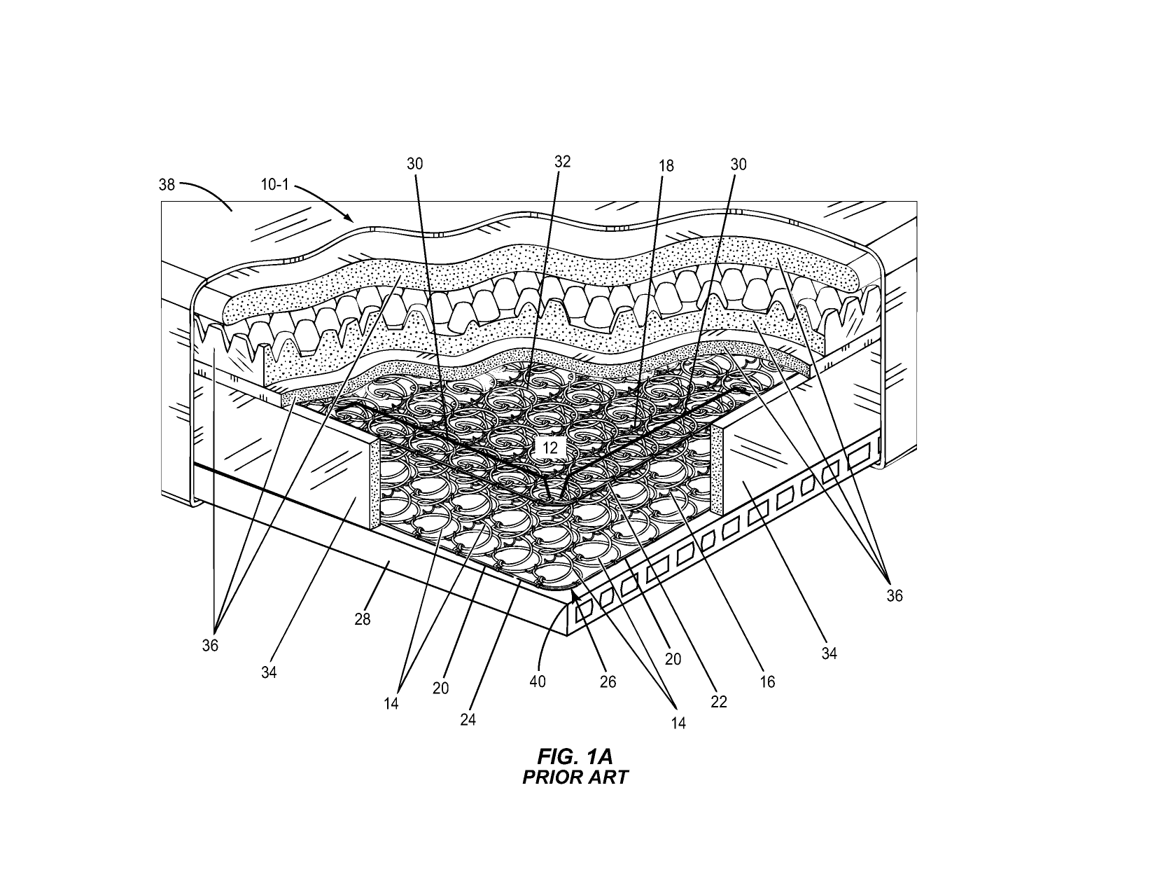

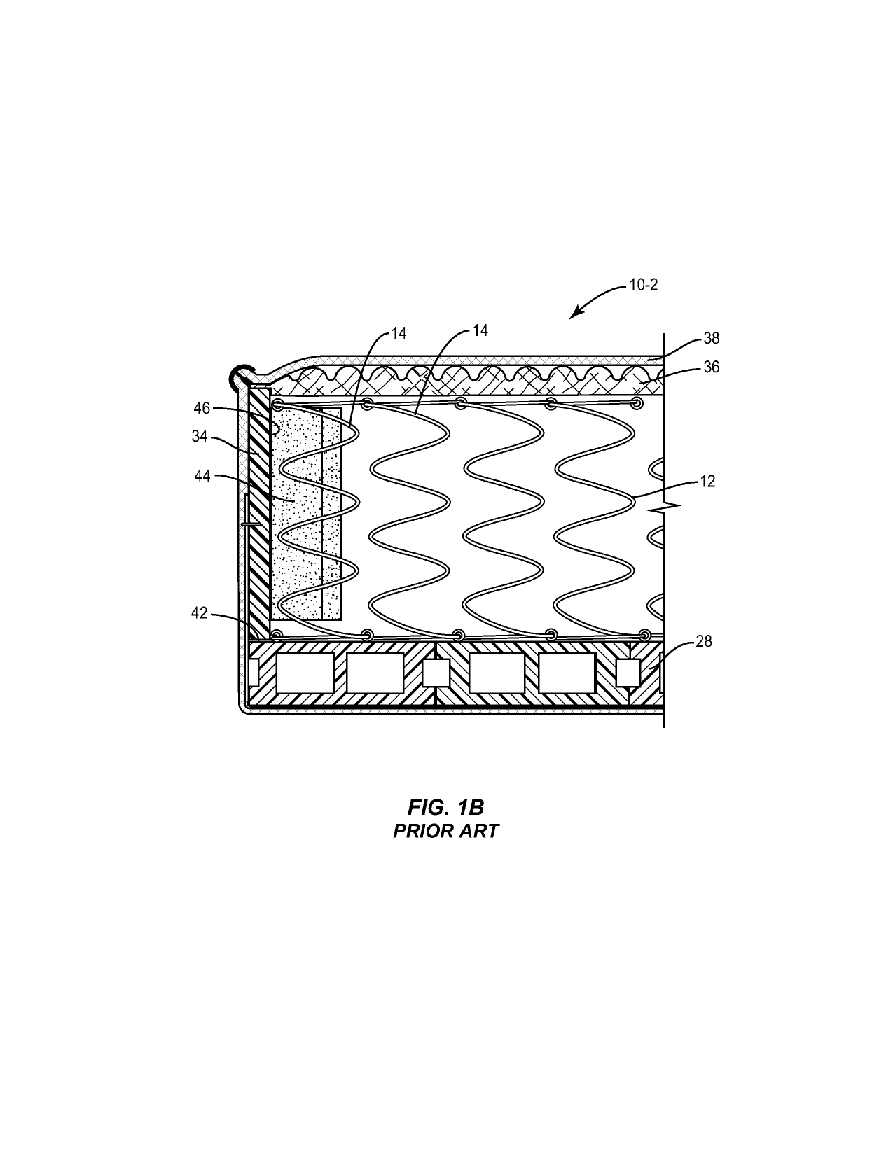

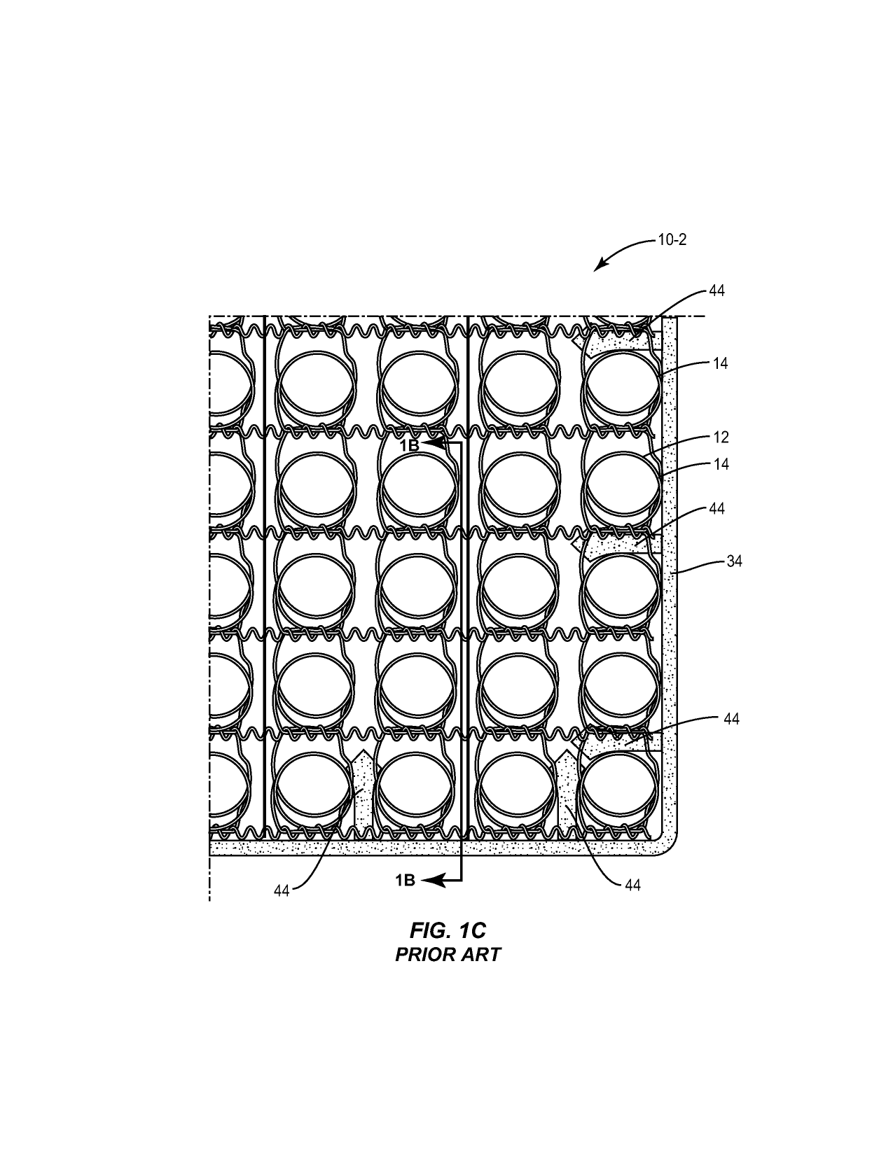

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Mattress assemblies and methods employing cloth member(s) thermally bonded to foam side support member(s) to form mattress encasements are disclosed. The foam side support members of the mattress assembly may be disposed adjacent to a periphery portion of a mattress core to provide additional support, for example, when a user mounts and dismounts from the mattress. A mattress assembly forms an encasement around the mattress core so that the side supports are secured precisely adjacent the periphery portion of the mattress core and the mattress core is able to support a weight of a user. The side support members are thermally bonded to cloth members to secure the side supports adjacent the periphery portion of the mattress core. The cloth members may include fibers which are compatible with being thermally bonded to foam side support members. In this manner, the side support members may be precisely positioned relative to the mattress core without the need for adhesives.

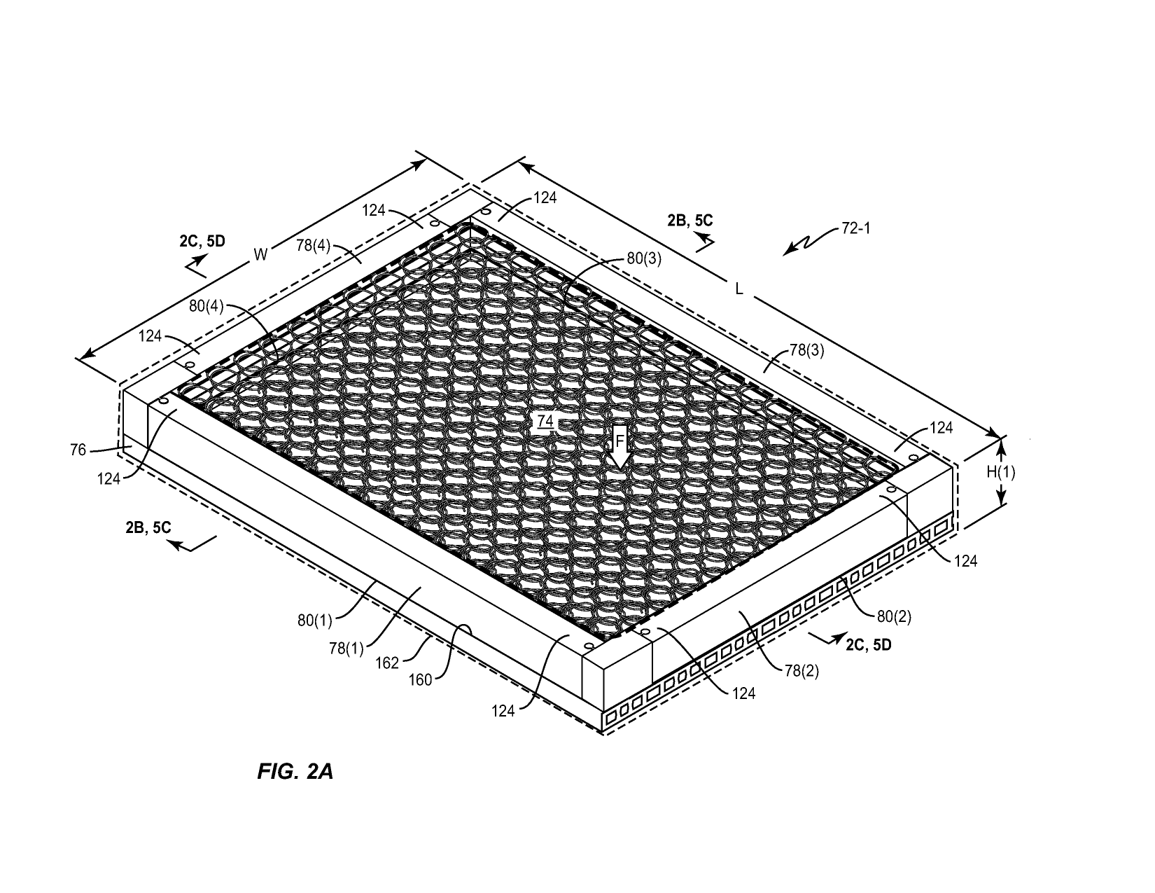

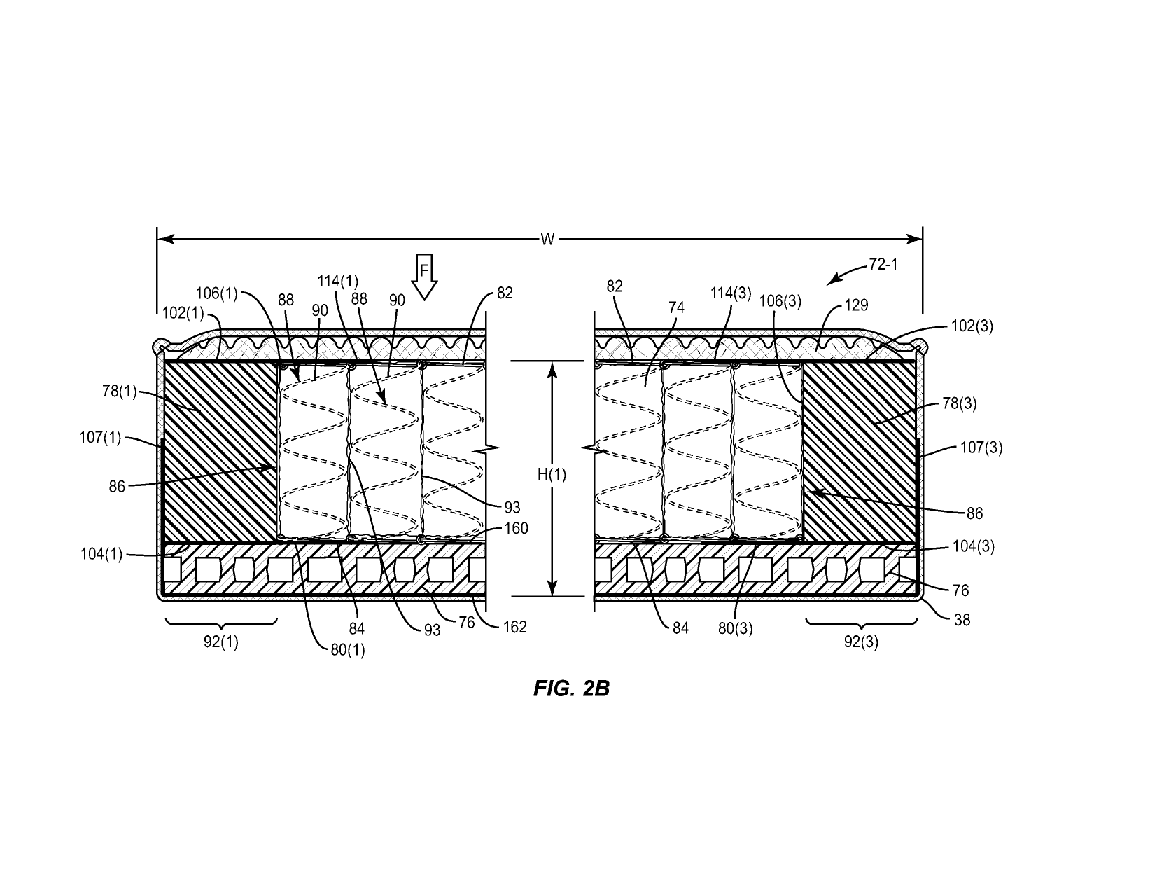

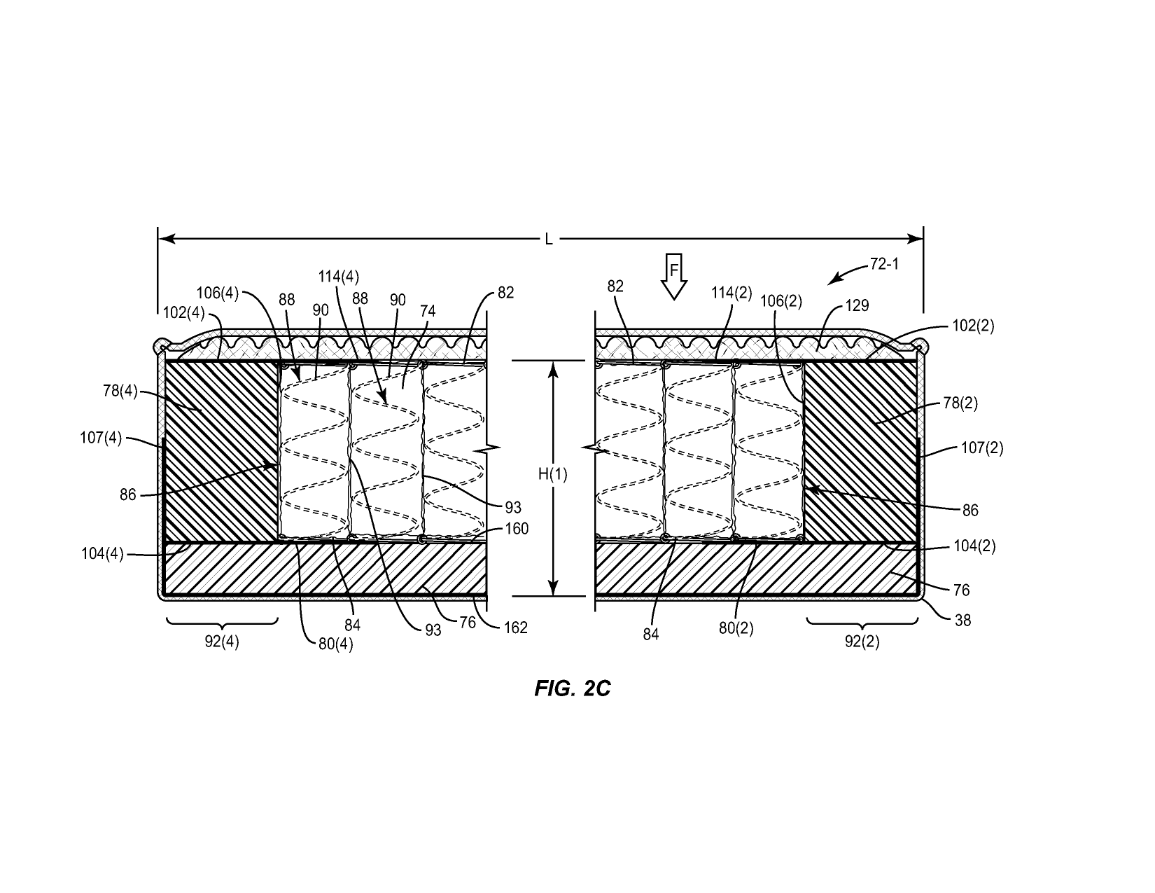

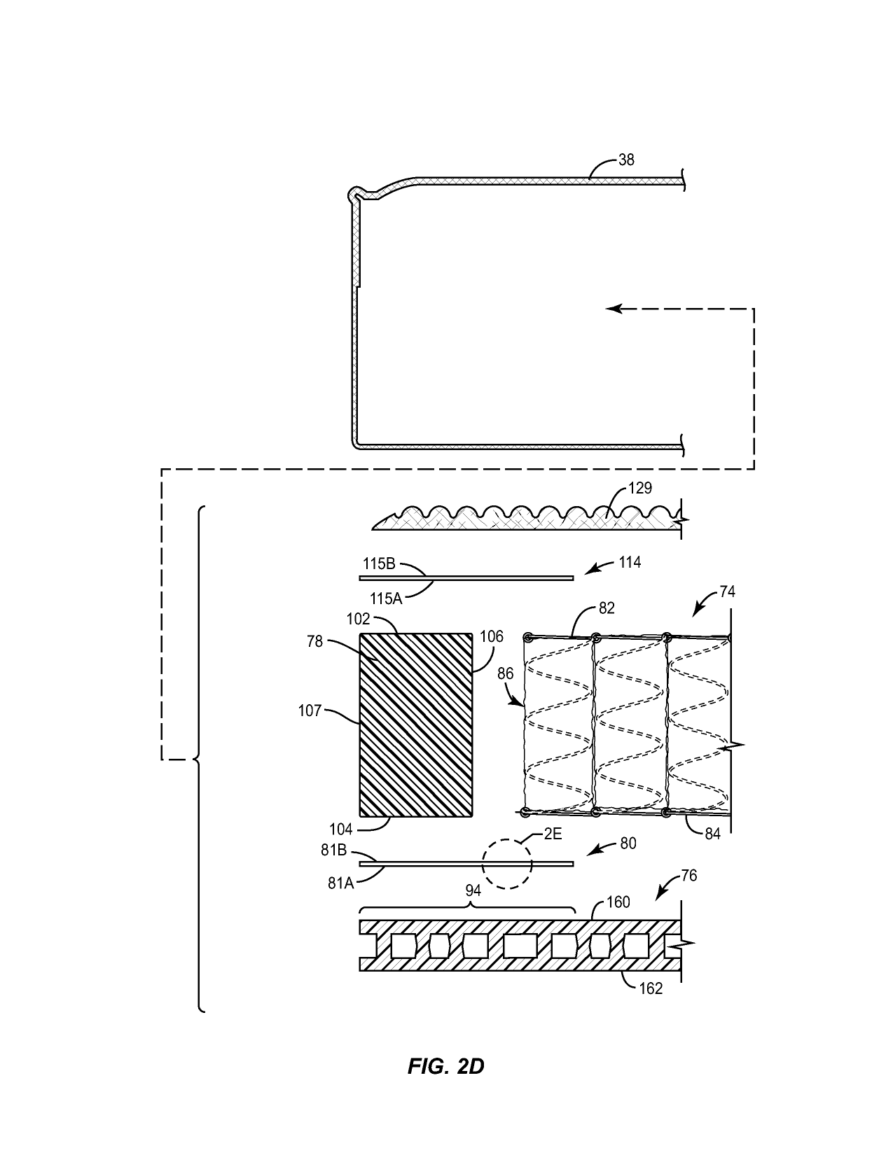

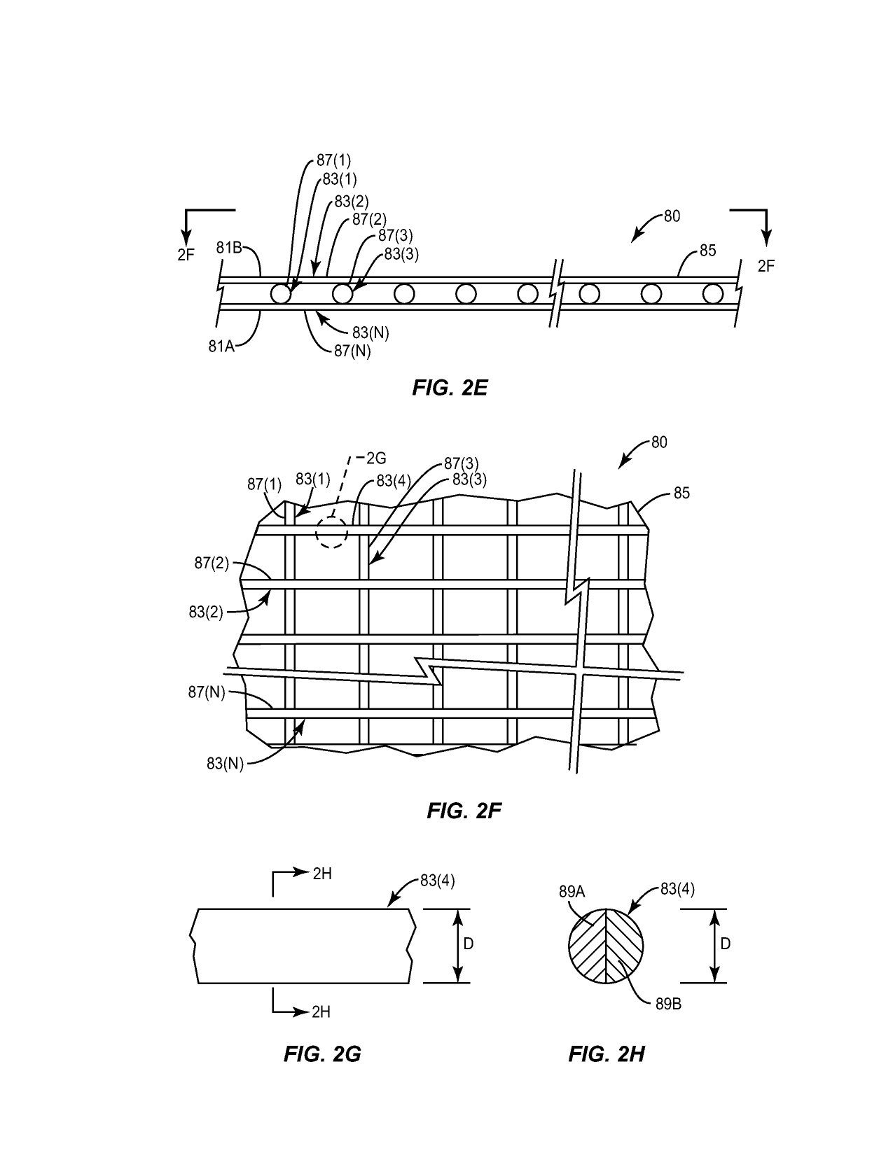

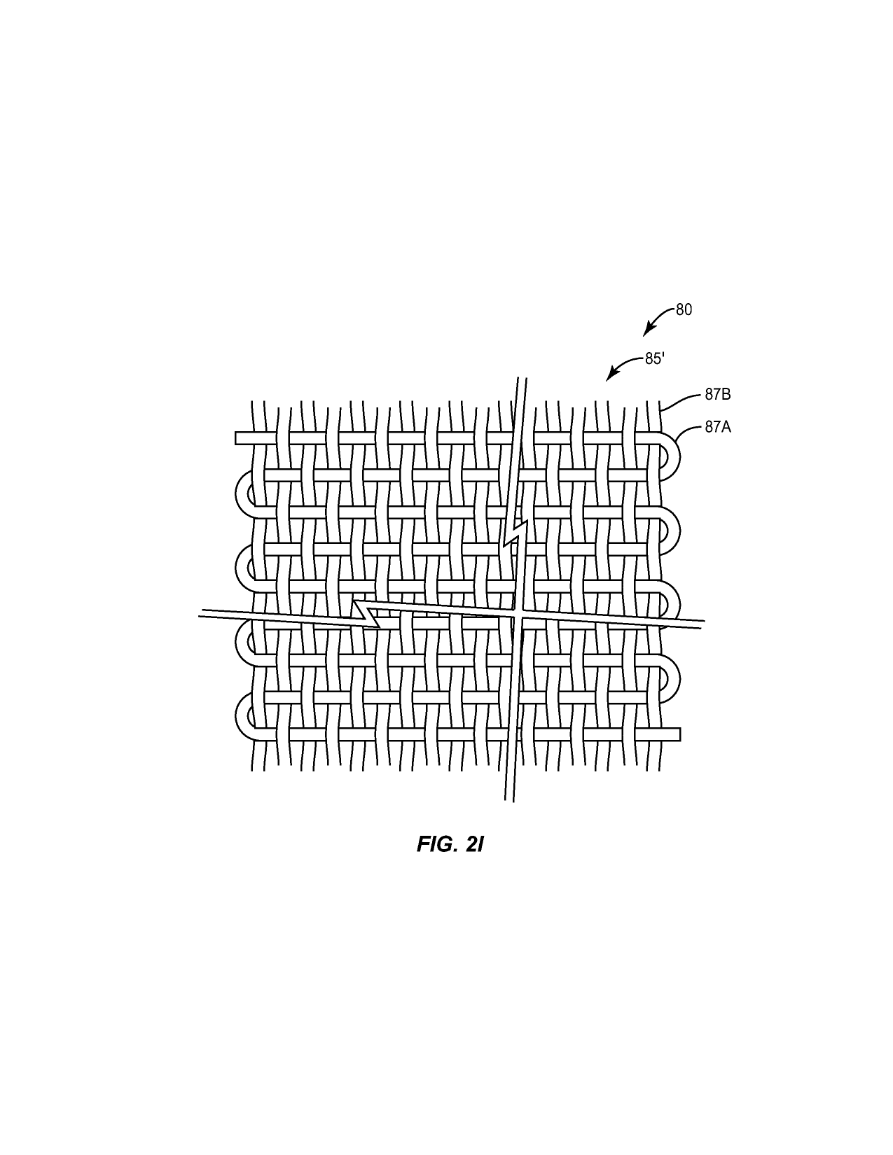

In this regard, FIGS. 2A, 2B and 2C depict a top perspective partial view and side views respectively of an exemplary mattress assembly 72-1 including a mattress core 74, a foam base 76, at least one foam side support member 78(1)-78(4), and at least one cloth member 80(1)-80(4). The foam base 76 and the at least one foam side support member 78(1)-78(4) may be made of any polymeric foam material containing polyolefins, for example, an extruded or molded closed-cell polyethylene foam.

The mattress core 74 may be disposed at a center of the mattress assembly 72-1 providing primary support to a user. The mattress core 74 may include a first support surface 82, second support surface 84, and periphery portion 86. The first support surface 82 may be configured to face the user applying a weight F (or “force”) to the mattress core 74. The second support surface 84 may be opposite the first support surface 82. The periphery portion 86 may connect the first support surface 82 and the second support surface 84. The mattress core 74 may further comprise at least one cushioning structure 88 of the mattress core 74. Embodiments of the cushioning structure 88 of the mattress core 74 may comprise, for example, a non-Marshall spring coil, a Marshall spring coil 90, thermoplastic layered foam, thermoset layered foam and/or an air bladder. FIGS. 2B and 2C depict the exemplary cushioning structure 88 as a Marshall spring coil 90 including a sleeve 93.

With continuing reference to FIGS. 2A through 2C, the foam base 76 supports the mattress core 74. The foam base 76 also forms a portion of an enclosure that surrounds the mattress core 74 to maintain the at least one foam side support member 78(1)-78(4) adjacent the periphery portion 86 of the mattress core 74. The foam base 76 may include a top side 160 and a bottom side 162. The mattress core 74 may be disposed adjacent the top side 160 of the foam base 76. The enclosure protects the integrity of the mattress core 74 by, for example, preventing the at least one cushioning structure 88 of the mattress core 74 from separating. The mattress assembly 72-1 may include the foam base 76 configured to support the weight F of the user transmitted through the mattress core 74.

The foam side support members 78(1)-78(4) provide a perimeter support structure around the mattress core 74 to provide side support for the mattress core 74, for example, when a user mounts or dismounts from the mattress assembly 72-1. The foam side support members 78(1)-78(4) are configured to be disposed adjacent the periphery portion 86 of the mattress core 74 to provide side support for the mattress core 74 supported by the foam base 76. The foam side support members 78(1)-78(4) also form another portion of the enclosure that surrounds the mattress core 74 and thereby may be attached to the foam base 76 via the at least one cloth member 80(1)-80(4) in combination with thermal bonding and/or adhesive.

Each of the at least one foam side support member 78(1)-78(4) comprises a first surface 102(1)-102(4) facing away from the foam base 76; a second surface 104(1)-104(4) facing the foam base 76 and disposed opposite the first surface 102(1)-102(4); an inner side surface 106(1)-106(4) facing the mattress core 74; and an outer side surface 107(1)-107(4) facing away from the mattress core 74. The second surface 104(1)-104(4) of the foam side support member 78(1)-78(4) or any other part of the foam side support member 78(1)-78(4) may be attached to the cloth member 80(1)-80(4). Further, the inner side surface 106(1)-106(4) of the foam side support member 78(1)-78(4) may abut the mattress core 74. This abutment enables the mattress core 74 to be horizontally positioned and may better distribute the weight of the user over a larger quantity of cushioning structures 88.

It is noted that a third cloth member 114(1)-114(4) may optionally be attached to the first surface 102(1)-102(4) of the foam side support members 78(1)-78(4). The third cloth member 114(1)-114(4) may also abut the first support surface 82 of the mattress core 74 to prevent the mattress core 74 from moving relative to the foam side support members 78(1)-78(4).

FIG. 2D is an exploded side view of the mattress assembly 72-1 depicted in FIG. 2B illustrating more details of the cloth members 80(1)-80(4) and their positional relationship to the foam side support members 78(1)-78(4) and the foam base 76. For terminology simplicity, in FIG. 2D the cloth members 80(1)-80(4) will be represented by the at least one cloth member 80, the third cloth members 114(1)-114(4) will be represented by the at least one third cloth member 114, and the foam side support members 78(1)-78(4) by the at least one foam side support member 78.

Given this simplified terminology, the at least one cloth member 80 includes a first end 81A thermally bonded to a peripheral portion 94 of the top side 160 of the foam base 76. The at least one cloth member 80 also includes a second end 81B thermally bonded to the second surface 104 of the at least one foam side support member 78 to secure the at least one foam side support member 78 adjacent to the periphery portion 86 of the mattress core 74. A first end 115A of the third cloth member 114 may be thermally bonded to the first surface 102 of the at least one foam side support member 78. In this manner, an enclosure may be formed around the mattress core 74 and thereby the at least one foam side support member 78 may remain adjacent to the periphery portion 86 of the mattress core 74 to provide side support. Consistent with this, the foam base 76 is free from direct attachment with the at least one foam side support member 78 because the foam base 76 may be indirectly attached to the at least one foam side support member 78 through the at least one cloth member 80. Also, the foam base 76 may be free from direct abutment with the at least one foam side support member 78 by having the at least one cloth member 80 disposed between the foam base 76 and the at least one foam side support member 78. In this manner, undesirable noises created by direct contact between the at least one foam side support member 78 and the foam base 76 may be avoided.

It is noted that in the preferred embodiment, a second end 115B of the third cloth member 114 may remain unattached to padding material 129 disposed atop the third cloth member 114. In this manner, the padding material 129 may provide more unrestricted cushioning for the user by allowing free movement between the third cloth member 114 and the upholstery 38. The padding material 129 may comprise soft material having cushioning characteristics, for example, viscoelastic foam.

FIGS. 2E and 2F are a side close-up view and a top close-up view, respectively, of the at least one cloth member 80 of FIG. 2D illustrating structural details of the at least one cloth member 80. The at least one cloth member 80 may be flexible and may include fibers 83(1)-83(N) bonded together in a structure by chemical, mechanical, heat, or solvent treatment. In one embodiment, the at least one cloth member 80 may be a nonwoven material 85. The nonwoven material 85 may be, for example, a bicomponent nonwoven fabric comprising polyethylene and polypropylene made by OXCO, Inc. of Charlotte, N.C., United States of America. The at least one cloth member 80 may comprise polyolefins for thermal bonding with the foam base 76 and the at least one foam side support member 78.

FIGS. 2G and 2H are close-up views of an exemplary fiber 83(4) of the at least one cloth member 80 of FIG. 2F. The fiber 83(4) may have a diameter D or equivalent diameter, for example, from 0.5 to 200 microns and preferably from 0.5 to 10 microns. The fibers 83(1)-83(N) of the at least one cloth member 80 may in one embodiment comprise bicomponent fibers 87(1)-87(N). The fibers 83(1)-83(N) may comprise at least twenty-five (25) percent polyethylene material 89A and/or may comprise at least twenty-five (25) percent polyethylene terephthalate material 89B. In a preferred embodiment, the at least one cloth member 80 may comprise the bicomponent fibers 87(1)-87(N) having polyethylene to polyethylene terephthalate in a 50/50 ratio, but acceptable values could also range from 25/75 to 75/25. The bicomponent fibers 87(1)-87(N) may further include polybutylene teraphthalate and/or polyamide.

In another example, depicted in FIG. 21, the at least one cloth member 80 may be a woven material 85′ comprising polyester fibers 87A for strength for attachment and polyethylene fibers 87B for softness to thereby provide good surface contact and compatibility with other surfaces (for example, on the at least one foam side support member 78 and/or the foam base 76). The polyethylene fibers 87B may also have a relatively low melting temperature, for example, from one hundred ten (110) to one hundred thirty (130) degrees Celsius, which does not affect the polyester fibers 87A having, for example, a melting temperature from two hundred fifty (250) to three hundred (300) degrees Celsius. The polyethylene fibers 87B may also provide thermal bonding compatibility between the at least one cloth member 80 and polyolefin foam which may be used as a material for the at least one foam side support member 78 and/or the foam base 76. In this manner, a strong attachment may be formed with the at least one cloth member 80. It is noted that the at least one third cloth member 114 may also include the same characteristics as those described for the at least one cloth member 80.

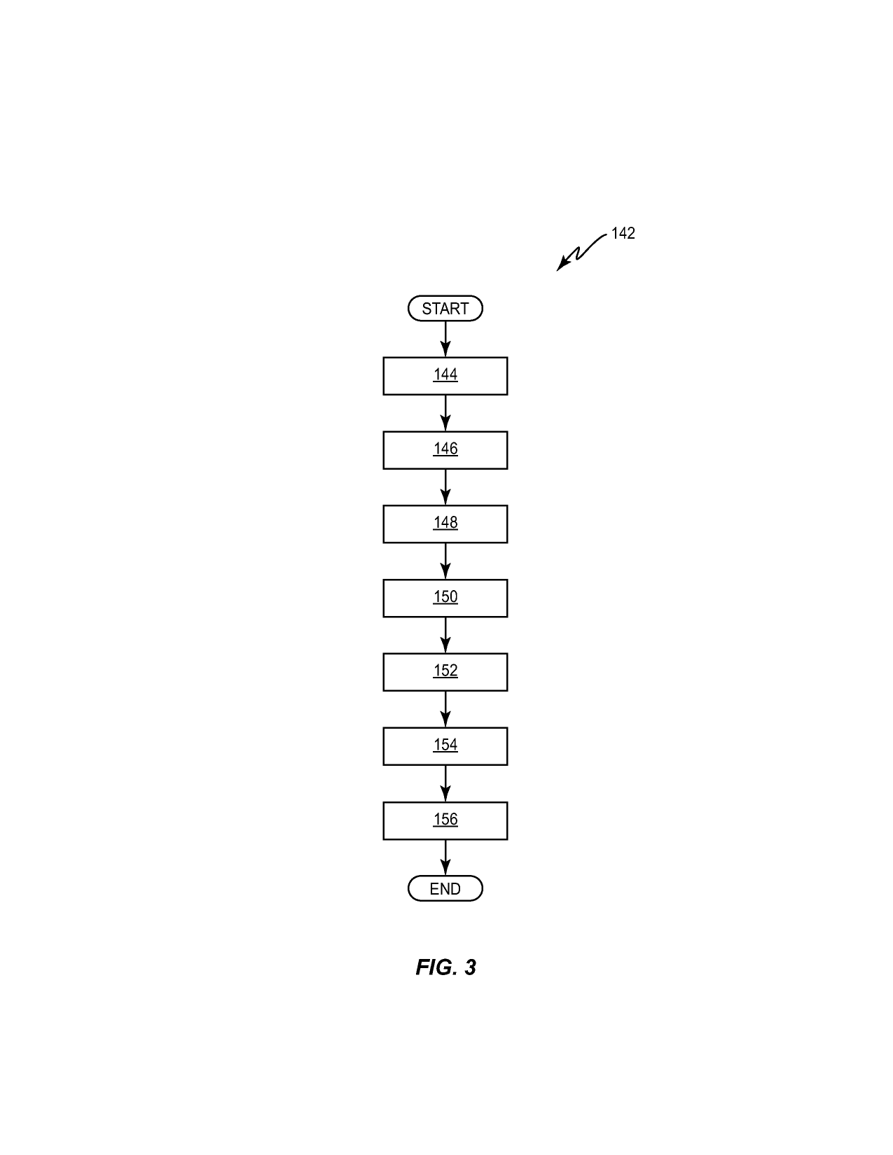

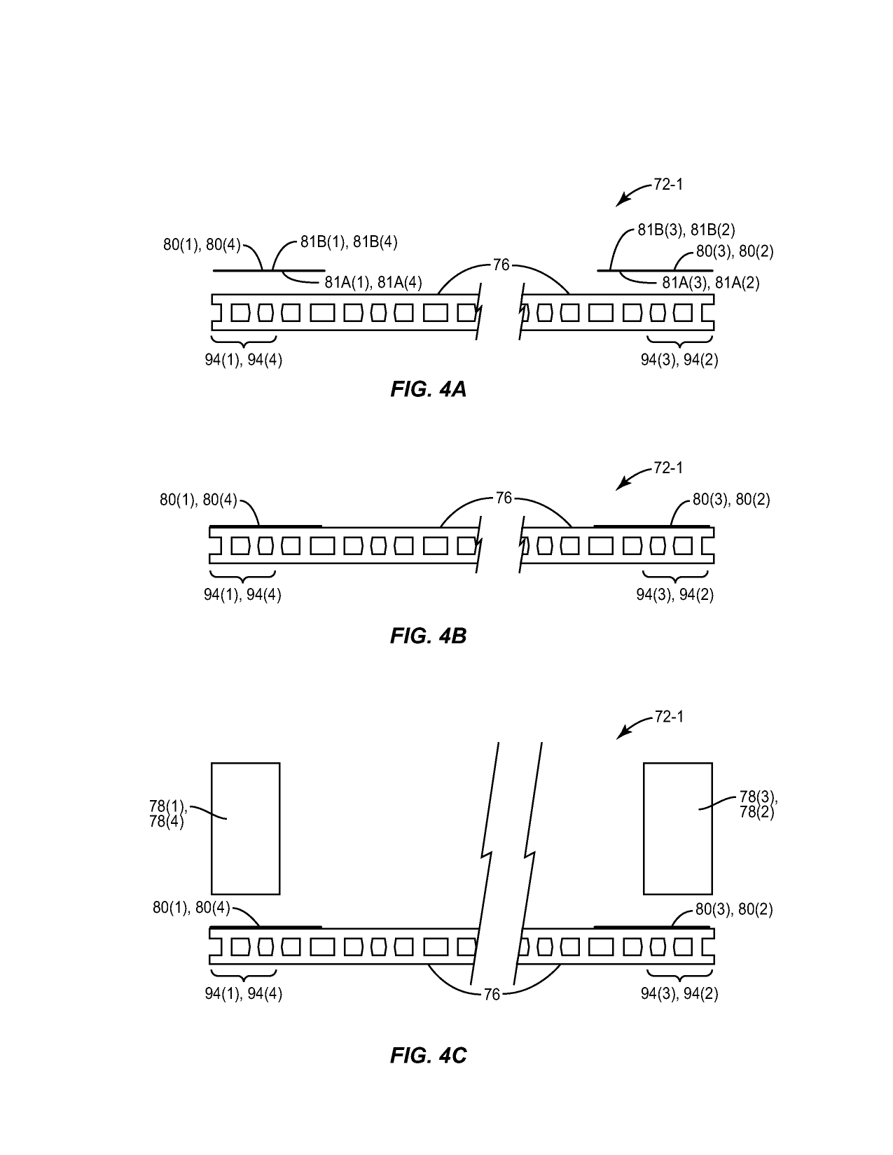

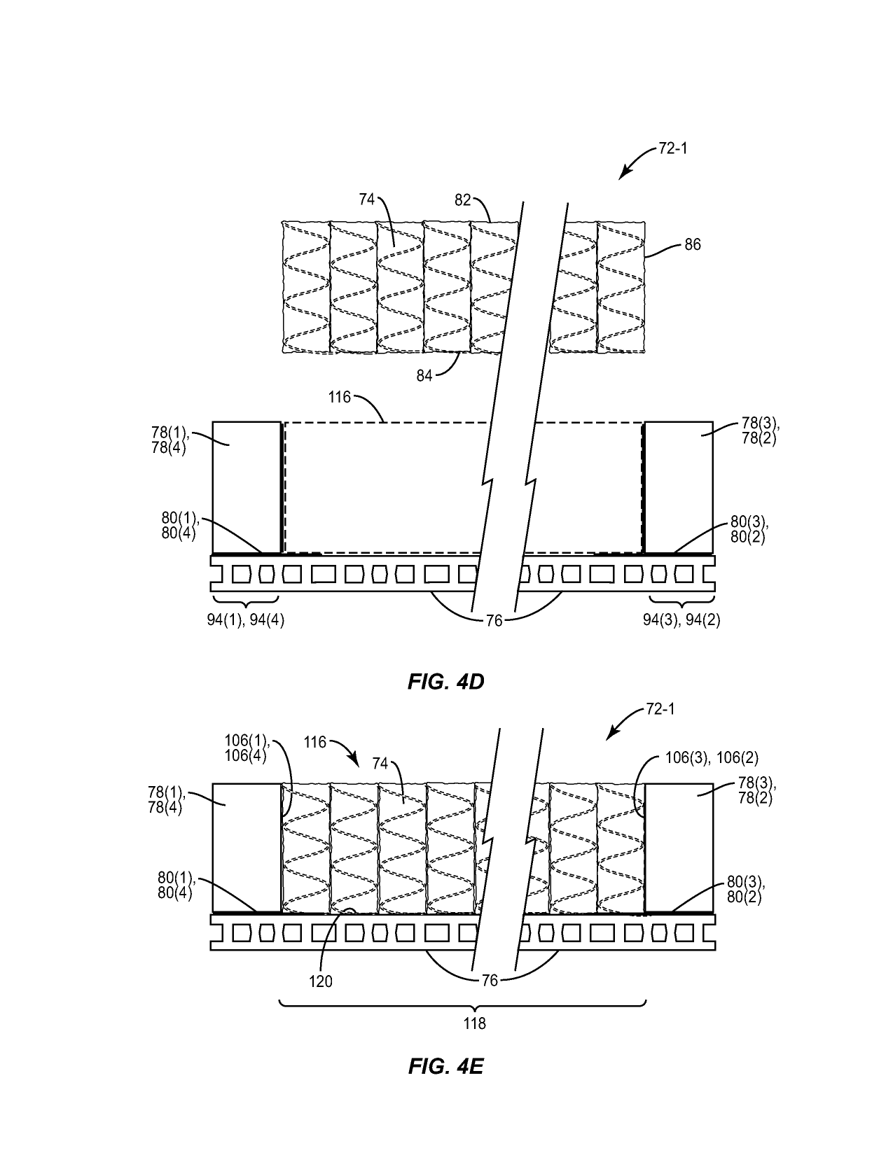

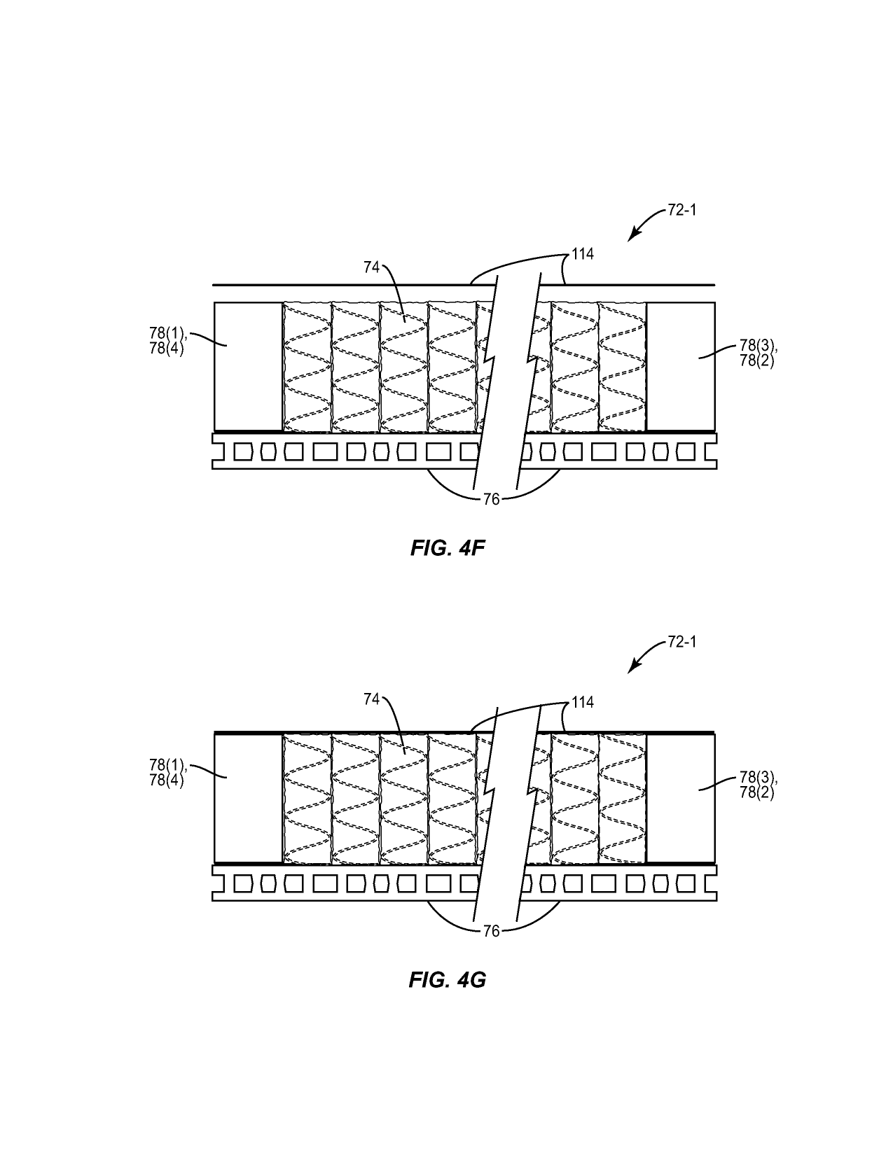

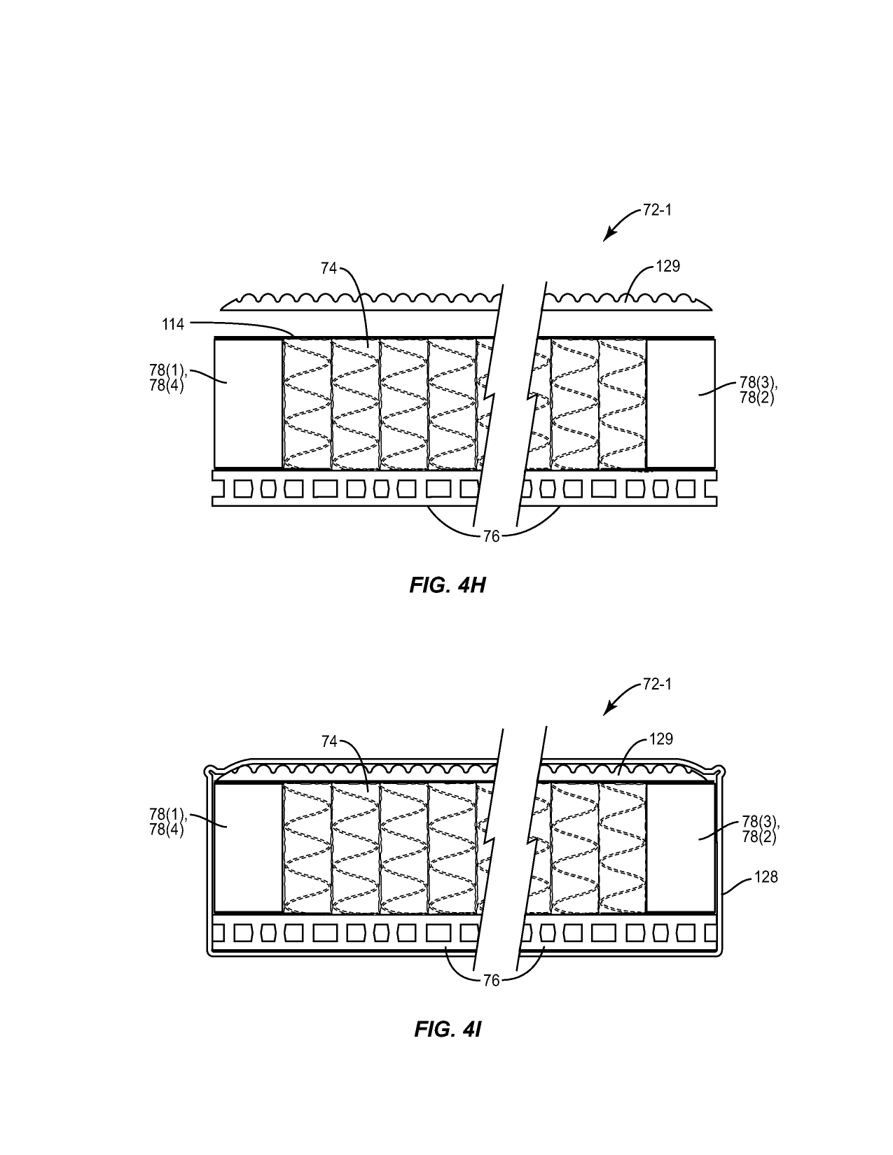

Now that the mattress assembly 72-1 has been introduced, an exemplary process 142 will be discussed for assembling the mattress assembly 72-1. In this regard, FIG. 3 is a flowchart diagram of the process 142 of assembling the mattress assembly 72-1. The process 142 in FIG. 3 will be described using terminology and information provided above. FIGS. 4A-4I generally correspond with blocks 144, 146, 148, 150, 152, 154, and 156, respectively, in FIG. 3, and will be discussed together.

As shown in FIG. 4A, the process 142 may include providing the foam base 76 (block 144 in FIG. 3). The foam base 76 may be configured to support the weight F of the user transmitted through the mattress core 74 (provided later). FIG. 4A also depicts the process 142 may include providing the at least one cloth member 80(1)-80(4) (block 146 in FIG. 3).

As shown in FIG. 4B, the process 142 may also include attaching the at least one cloth member 80(1)-80(4) to the peripheral portion 94(1)-94(4) of the foam base 76 (block 148 in FIG. 3). The first end 81A of the at least one cloth member 80(1)-80(4) may be attached to the peripheral portion 94(1)-94(4) of the foam base 76 with an adhesive and/or thermal bonding. The adhesive may be, for example, a hot melt adhesive. The thermal welding may be accomplished, for example, through a use of a hot plate, hot air, and/or ultrasonics.

FIG. 4C depicts that the process 142 may include providing the least one foam side support member 78(1)-78(4) (block 150 in FIG. 3). The foam side support member 78(1)-78(4) may be attached to the peripheral portion 94(1)-94(4) of the at least one cloth member 80(1)-80(4) with an adhesive and/or thermal bonding. The adhesive may be, for example, a hot melt adhesive. The thermal welding may be accomplished, for example, through a use of a hot plate, hot air, and/or ultrasonics. The first end 81A of the at least one cloth member 80(1)-80(4) may be attached to the foam side support member 78(1)-78(4). The first end 81A may be opposite of the second end 81B. Alternatively, it is noted that the at least one cloth member 80(1)-80(4) may be attached to the at least one foam side support member 78(1)-78(4) before being attached to the foam base 76.

FIGS. 4D and 4E illustrate that the process 142 may include providing the mattress core 74 and inserting the mattress core into the interior space 116 (block 152 in FIG. 3). The mattress core 74 may include the first support surface 82 configured to face the user which may apply their weight F to the mattress core 74. The mattress core 74 may also include a second support surface 84 which may be opposite the first support surface 82. The mattress core 74 may also include a periphery portion 86 connecting the first support surface 82 with the second support surface 84. The interior space 116 may be formed by the inner side surface 106(1)-106(4) of each of the foam side support member 78(1)-78(4) and a portion 118 of the inner base surface 120 of the foam base 76. The portion 118 of the inner base surface 120 may face the mattress core 74.

FIGS. 4F and 4G illustrates that the process 142 may include optionally attaching the third cloth member 114 with an adhesive and/or thermal bonding to the foam side support member 78(1)-78(4) and the mattress core 74 to prevent the mattress core 74 from departing the interior space 116 (block 154 in FIG. 3). As shown in FIG. 4H, the padding material 129 may be included as part of the mattress assembly 72-1. The padding material 129 may be located between the user and the mattress core 74 to provide more comfort to the user. The padding material 129 may be made of a soft resilient material, for example, viscoelastic foam. As shown in FIG. 4I, ticking 128 may be added to form an exterior surface surrounding the other components, as well as the padding material 129 disposed between the ticking 128 and the mattress core 74 (block 156 in FIG. 3). Alternatively, the mattress assembly 72-1 may optionally not include the ticking 128 and/or the padding material 129 to reduce cost.

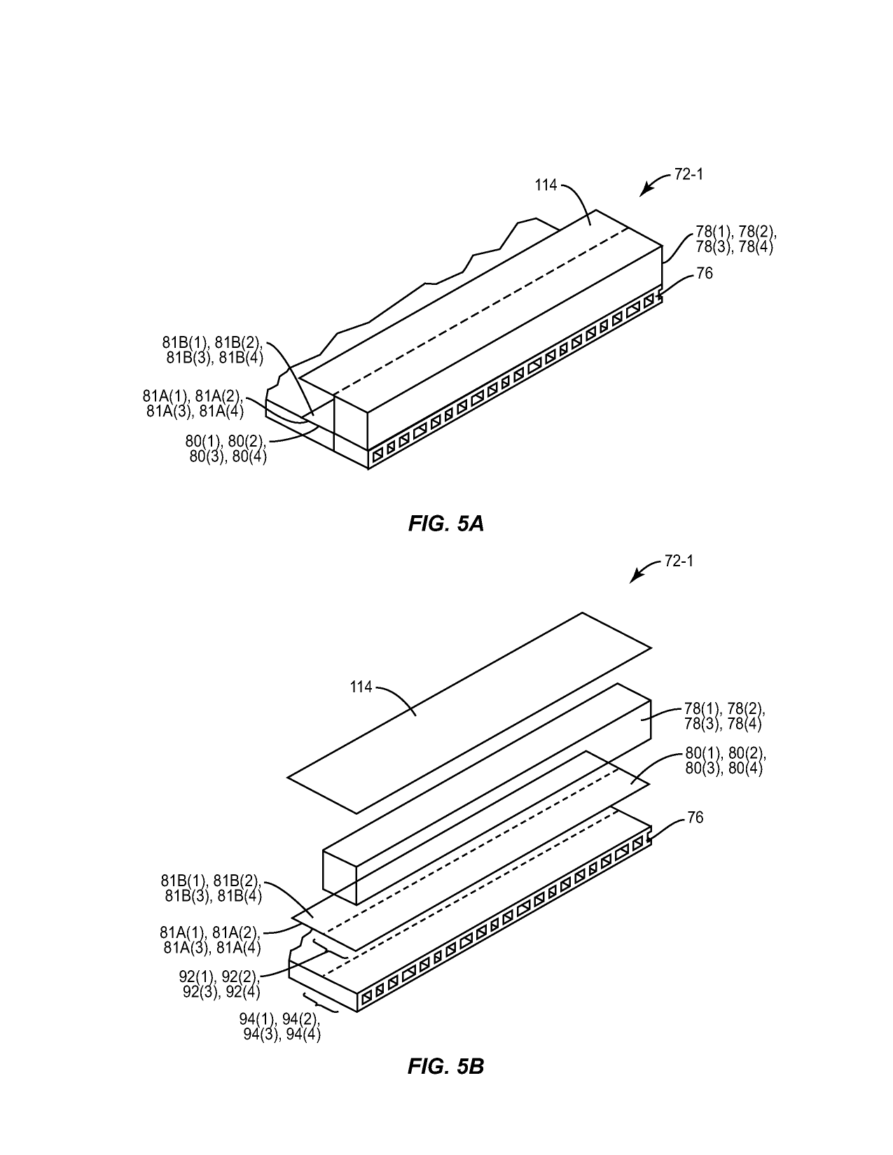

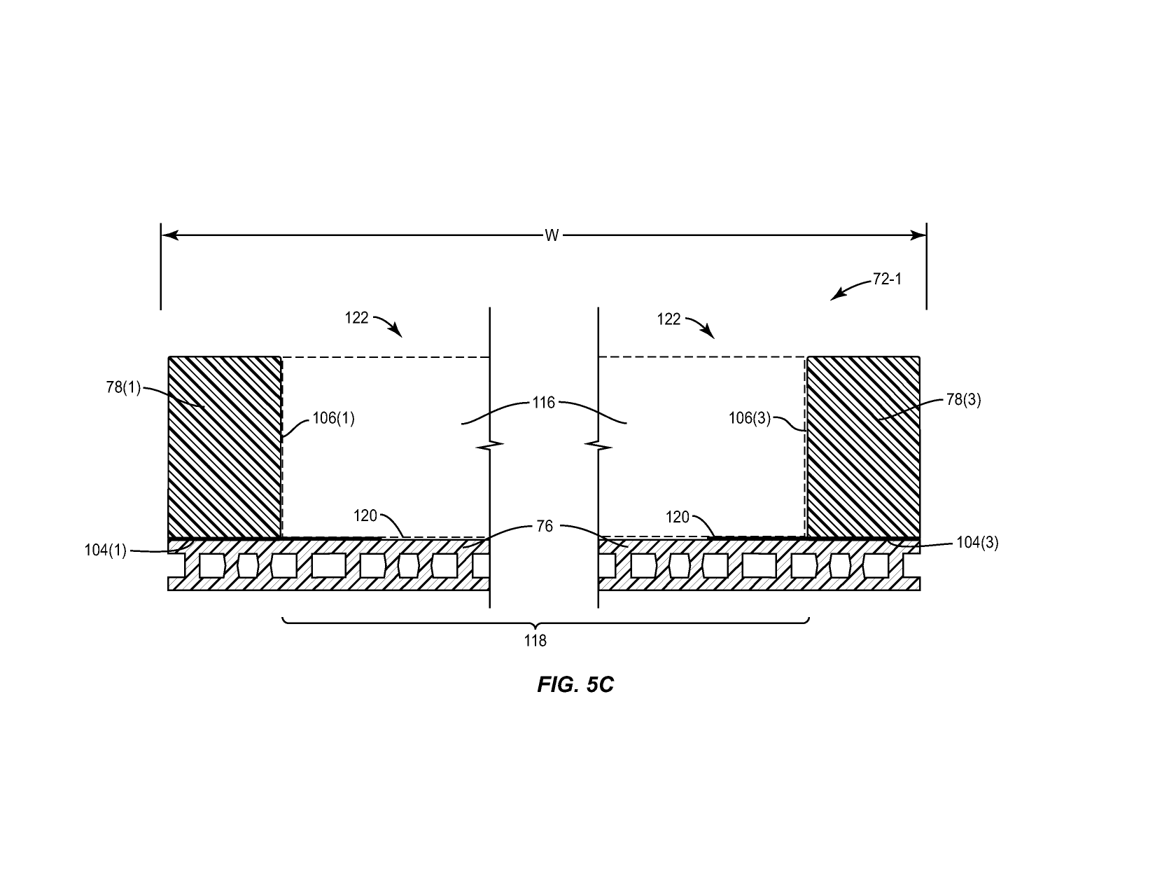

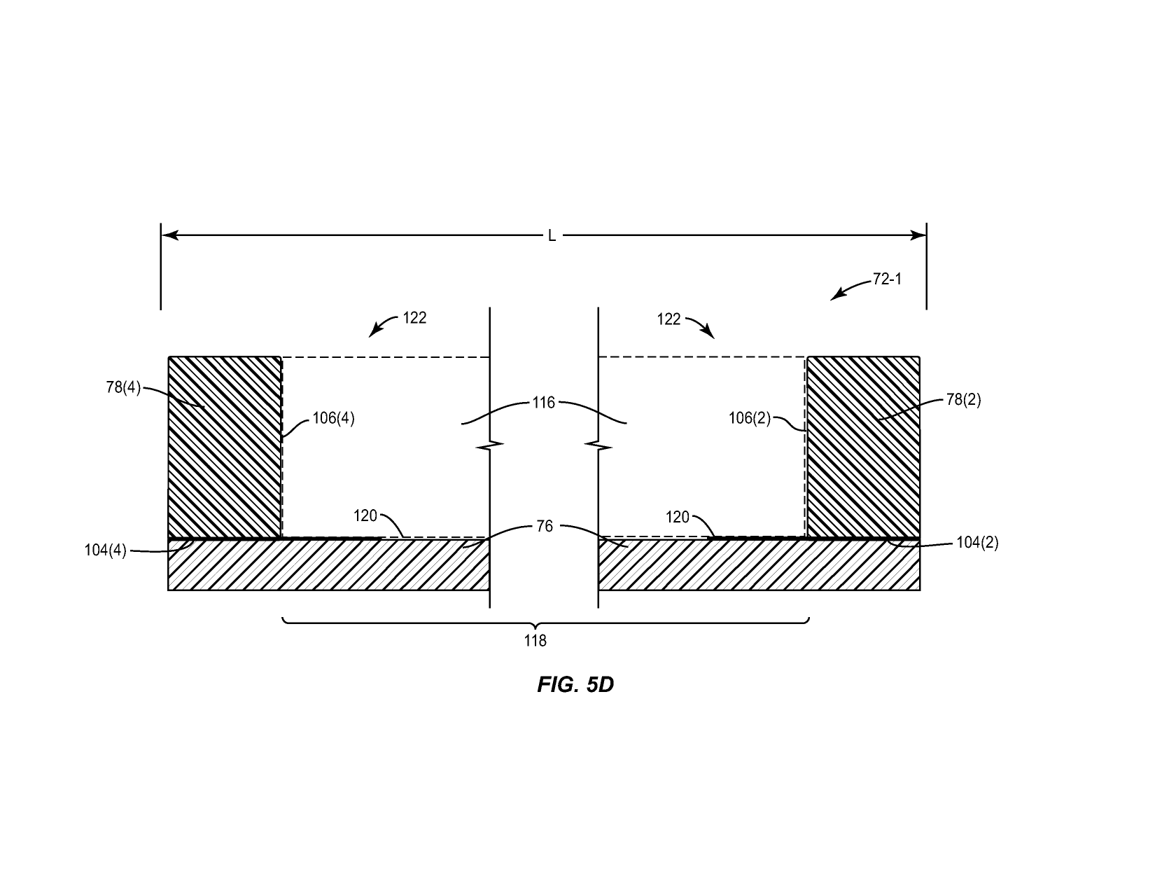

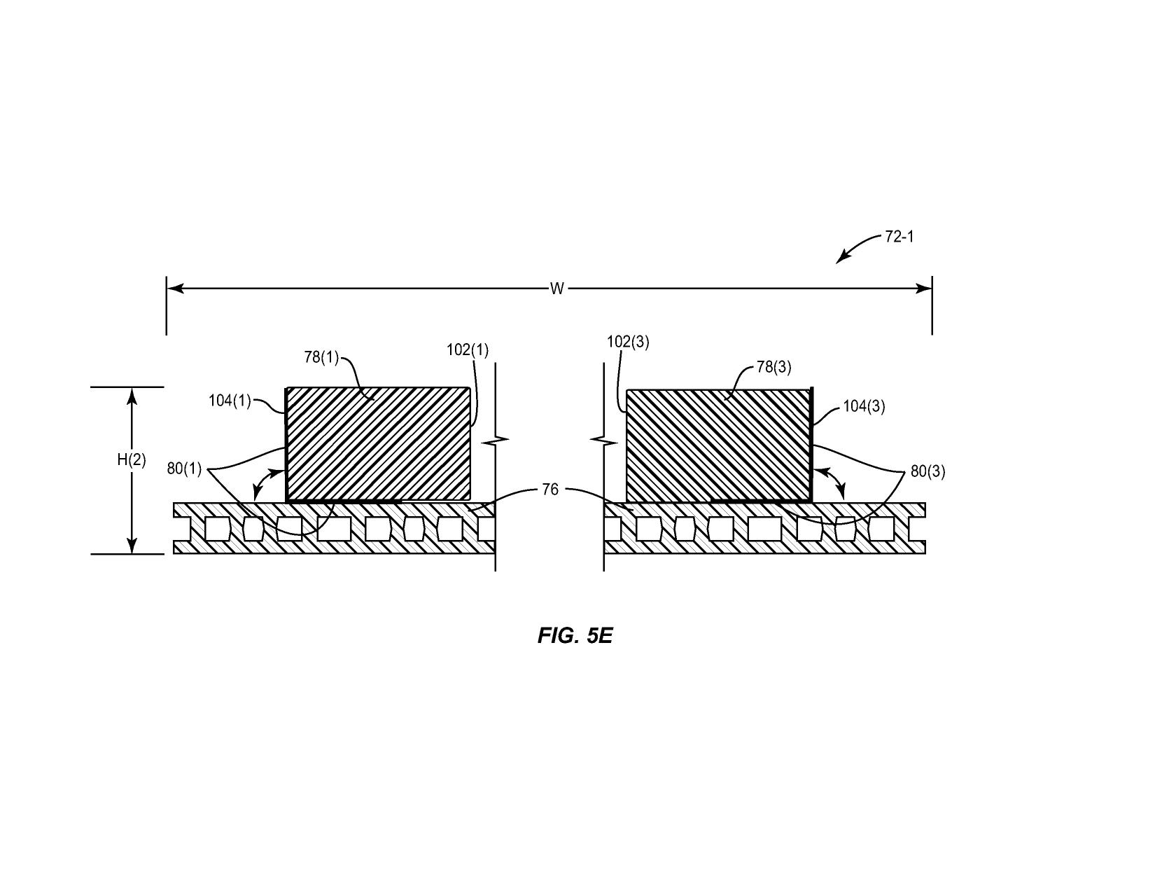

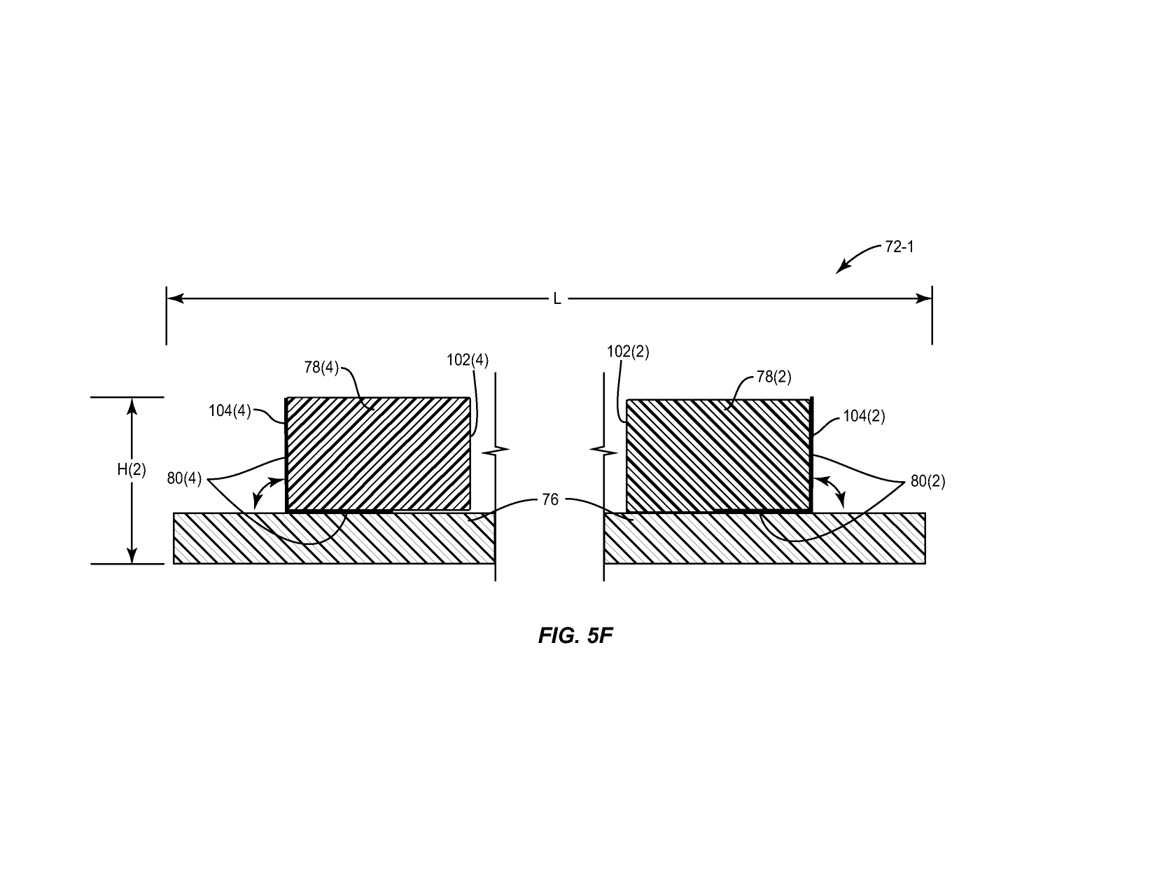

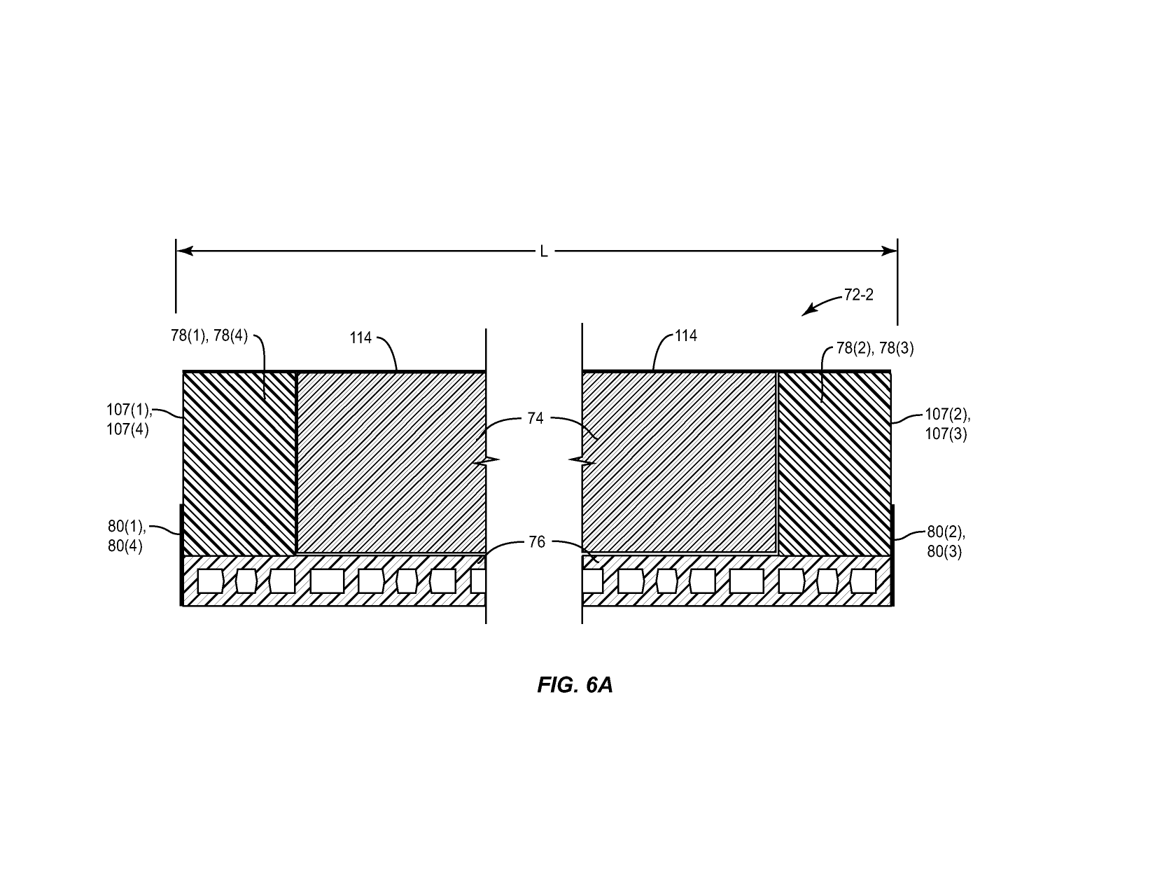

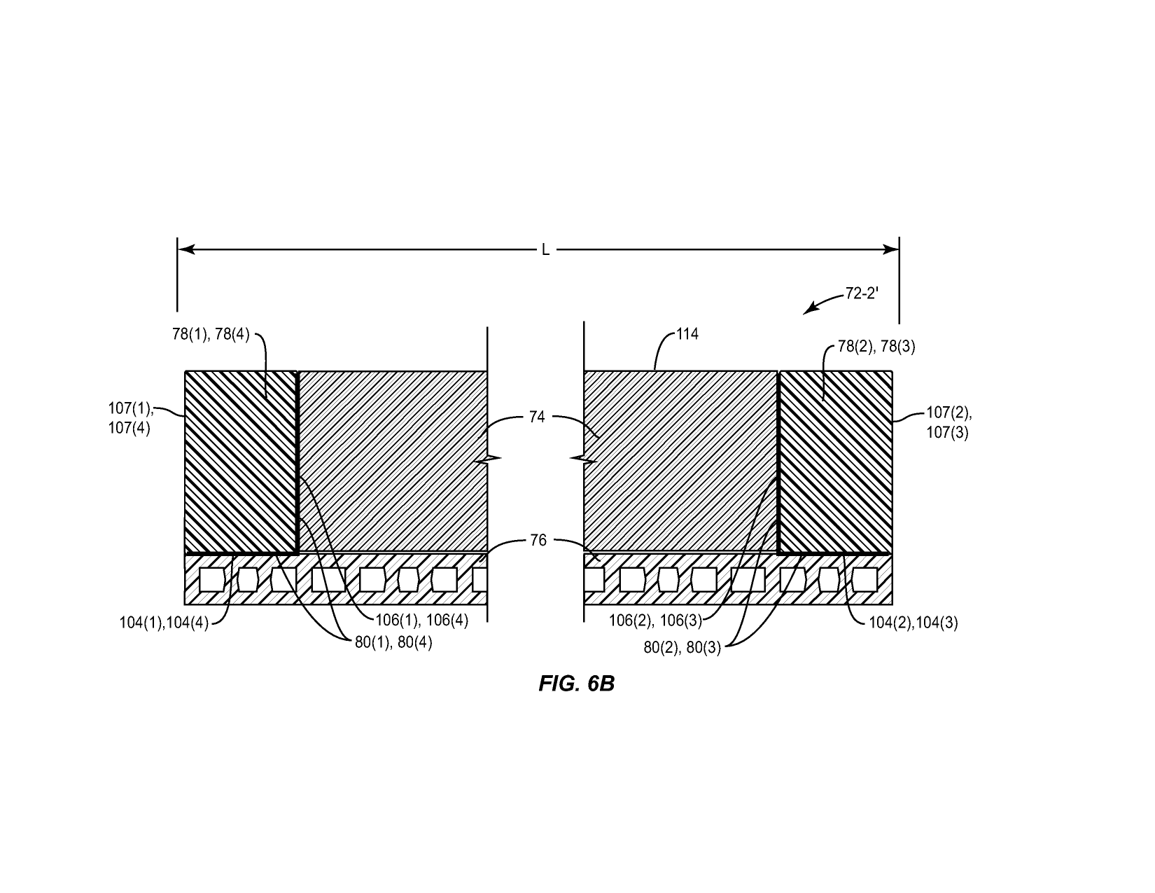

Now that the process 142 has been described, FIGS. 5A and 5B provide a top perspective view and a top perspective exploded view of the mattress assembly 72-1 with the mattress core 74 hidden. As shown in FIGS. 5A and 5B, the at least one cloth member 80(1)-80(4) serves as an attachment member between the foam base 76 and the at least one foam side support member 78(1)-78(4). At least the portion 92(1)-92(4) of the at least one cloth member 80(1)-80(4), respectively, may be disposed between the peripheral portion 94(1)-94(4) of the foam base 76 and the at least one foam side support member 78(1)-78(4). The at least one cloth member 80(1)-80(4) may be disposed between the foam base 76 and the foam side support member 78(1)-78(4) to prevent the foam base 76 and the foam side support member 78(1)-78(4) from contacting or abutting and thereby generating unacceptable noise, which some describe as a crunchy sound of a potato chip bag being opened or crumpled. As several components of the mattress assembly 72-1 support the weight F of the user, the several components may have different cushioning characteristics to provide comfort to the user yet provide a required firmness.

It is noted that when either or both of the foam base 76 and the foam side support member 78(1)-78(4) are attached to the at least one cloth member 80(1)-80(4) with thermal bonding, then the at least one cloth member 80(1)-80(4) may be made of a thermoplastic material, for example, that is compatible to be welded. The at least one cloth member 80(1)-80(4) may include polyolefins to thermally bond with the foam base 76 and the foam side support member 78(1)-78(4). The adhesive attachment and/or thermal bonding attachment options enable more manufacturing efficiency by enabling the economic advantage of the thermal bonding or the low temperature advantage of the adhesive. It is also noted that in some embodiments, the at least one cloth member 80(1)-80(4) may be folded one-hundred eighty (180) degrees so that the second end 81B(1)-81B(4) may be attached to both the foam side support member 78(1)-78(4) and the foam base 76. The at least one cloth member 80(1)-80(4) when folded may effectively contain the mattress core 74 within an interior space 116 of the mattress assembly 72-1, yet provide a pivotable attachment between the foam side support member 78(1)-78(4) and the foam base 76.

FIG. 5C and 5D are sectional side views of the mattress assembly 72-1 of FIG. 5A. The third cloth member 114 (shown in FIG. 5A) may be configured to prevent the mattress core 74 from departing from an interior space 116 (FIGS. 4D and 4E) formed by the inner side surface 106(1)-106(4) of each of the foam side support member 78(1)-78(4) and a portion 118 of an inner base surface 120 of the foam base 76. The portion 118 of the inner base surface 120 may face and support the mattress core 74. The interior space 116 (see FIGS. 4D and 4E) may comprise an opening 122. The opening 122 may be opposite the portion 118 of the inner base surface 120 to enable the mattress core 74 to abut against the inner base surface 120 when not departing the opening 122.

The third cloth member 114 may be attached to at least portions 124 (see FIG. 2A) of the foam side support member 78(1)-78(4) to at least partially close the opening 122 and thereby prevent the mattress core 74 from departing the interior space 116. As shown in FIG. 2A, the portions 124 may be close to the corners 126 of the mattress assembly 72 to enable the third cloth member 114 to more easily straddle the mattress core 74 between two portions that are relatively close together. The third cloth member 114 may be a multi-piece or single-piece structure to reduce cost.

FIGS. 5E and 5F depict a sectional side view of the mattress assembly 72-1 of FIGS. 4A and 4B wherein the foam side support members 78(1)-78(4) are pivoted with respect to the foam base 76. The at least one cloth member 80(1)-80(4) is utilized as a hinge to enable the pivoting which reduces a height of the mattress assembly from H(1) (see FIG. 2C) to H(2). The shorter height H(2) enables the mattress assembly 72-1 to be more easily shipped or stored prior to assembly with other components of the mattress assembly 72-1.

FIG. 6A is a sectional side view of a mattress assembly 72-2 which is another embodiment of the mattress assembly 72-1. The mattress assembly 72-2 may contain similar components as mattress assembly 72-1; however, the location of the at least one cloth member 80(1)-80(4) may be different. Specifically, the at least one cloth member 80(1)-80(4) may be attached to the outer side surface 107(1)-107(4) of the foam side support member 78(1)-78(4) and the foam base 76. In this manner, the at least one cloth member 80(1)-80(4) may not be disposed between the foam base 76 and the foam side support member 78(1)-78(4) and the attachment may be conveniently made after the components have been positioned relative to each other.

The at least one cloth member 80 may also be used to reduce noise by a mattress during use. In this regard, FIG. 6B is a sectional side view of a mattress assembly 72-2′ which is another embodiment of the mattress assembly 72-1. The mattress assembly 72-2′ may contain all the same components as mattress assembly 72-1; however, the location of the at least one cloth member 80(1)-80(4) may be different. Specifically, the at least one cloth member 80(1)-80(4) may be attached to the at least one second surface 104(1)-104(4) of the at least one foam side support member 78(1)-78(4), respectively, and the foam base 76, but the at least one cloth member 80(1)-80(4) may also be attached to the at least one inner side surface 106(1)-106(4) of the at least one foam side support member 78(1)-78(4), respectively. The attachments may be accomplished using thermal welding and/or adhesives as discussed above. In this manner, the at least one cloth member 80(1)-80(4) may be disposed between the foam core 74 and the foam side support member 78(1)-78(4) to reduce friction between the at least one foam side support member 78(1)-78(4) and the foam core 74. The friction that is reduced may otherwise produce undesirable noise during use of the mattress assembly.

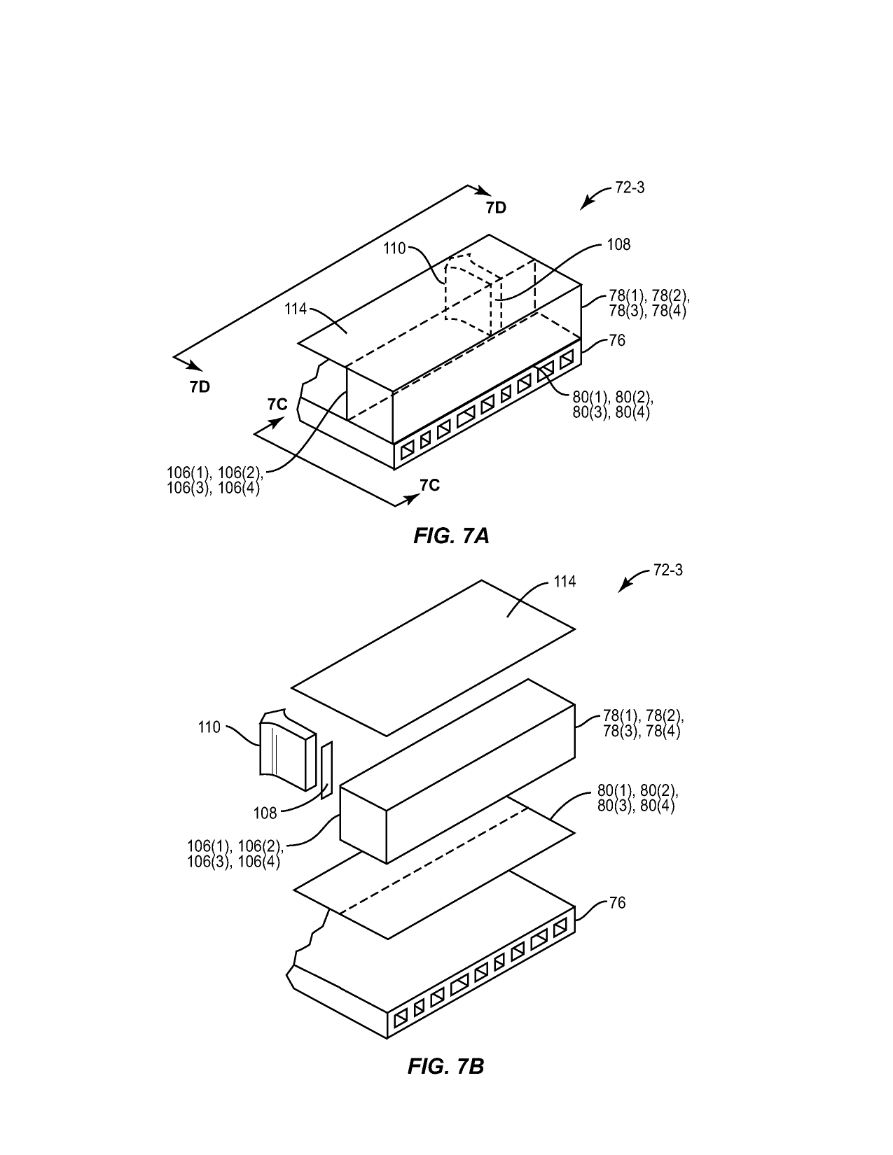

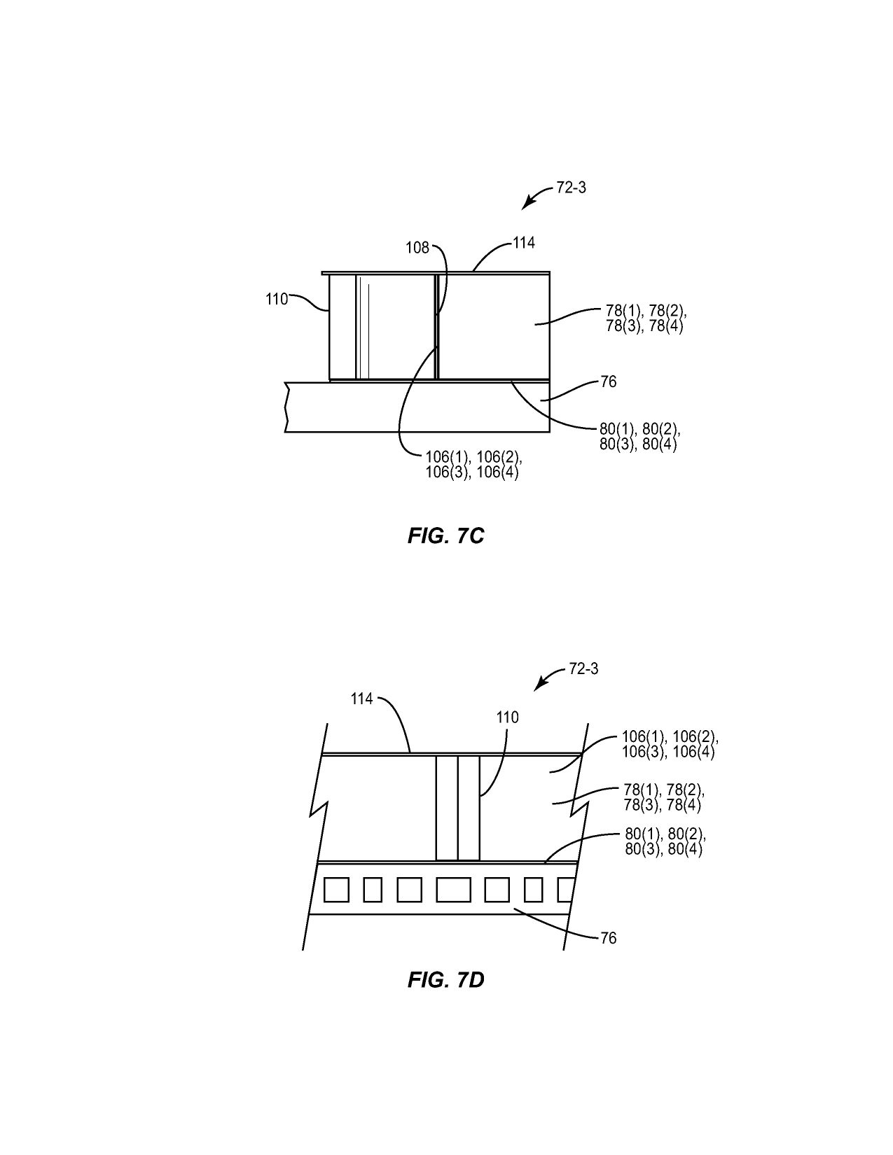

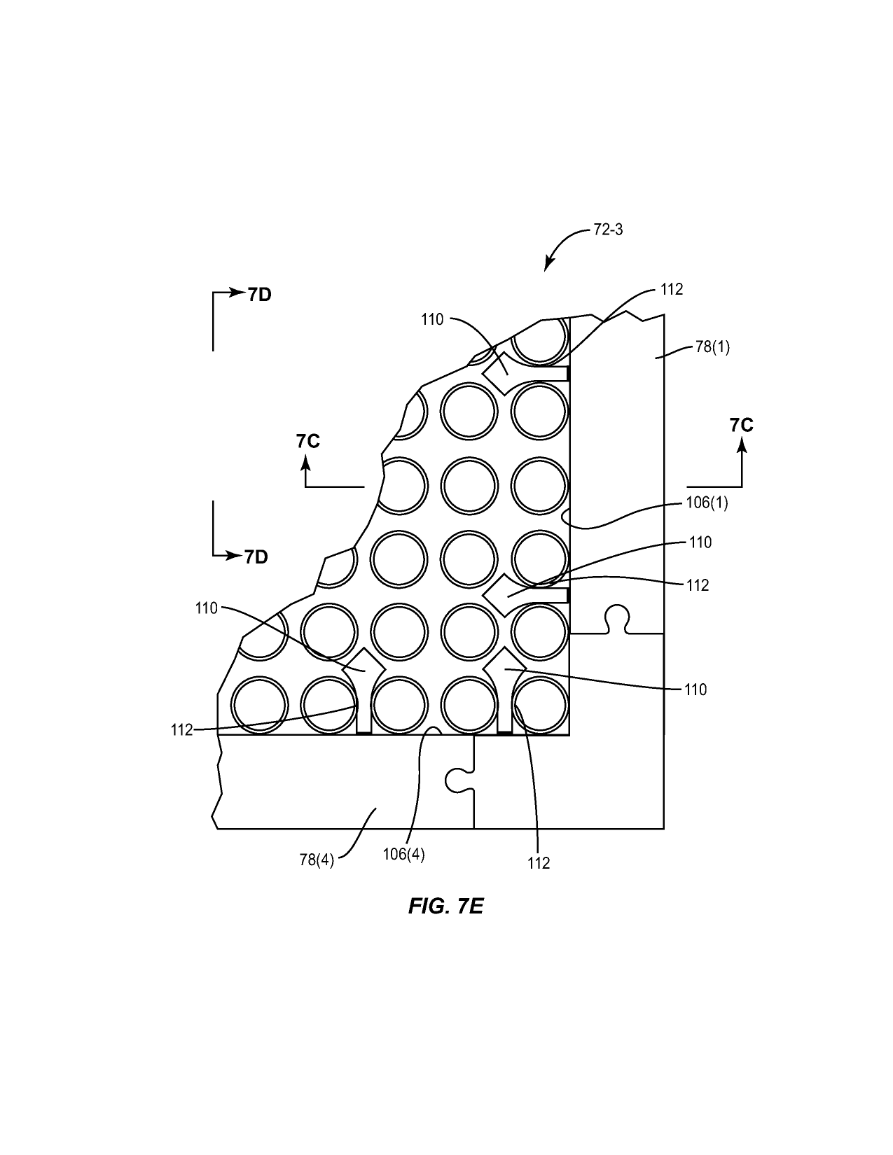

FIGS. 7A through 7E depict a top perspective view, a top perspective exploded view, side views, and a top view, respectively, of a mattress assembly 72-3 which is a another embodiment of the mattress assembly 72-1. The mattress assembly 72-3 may be distinguished from mattress assembly 72-1 by at least one second cloth member 108 and at least one foam engagement member 110. The second cloth member 108 may be attached to the inner side surface 106(1)-106(4) and the foam engagement member 110 with an adhesive and/or thermal bonding. The foam engagement member 110 may form at least one frictional fit or interference fit 112 with the mattress core 74. Therefore, the second cloth member 108 which is not orthogonal to the direction of the weight of the user may be used to attach foam surfaces where tension and compression may be experienced. The second cloth member 108 may have a structure similar to that described above for the at least one cloth member 80(1)-80(4) and thus will not be discussed further to reduce redundancy.

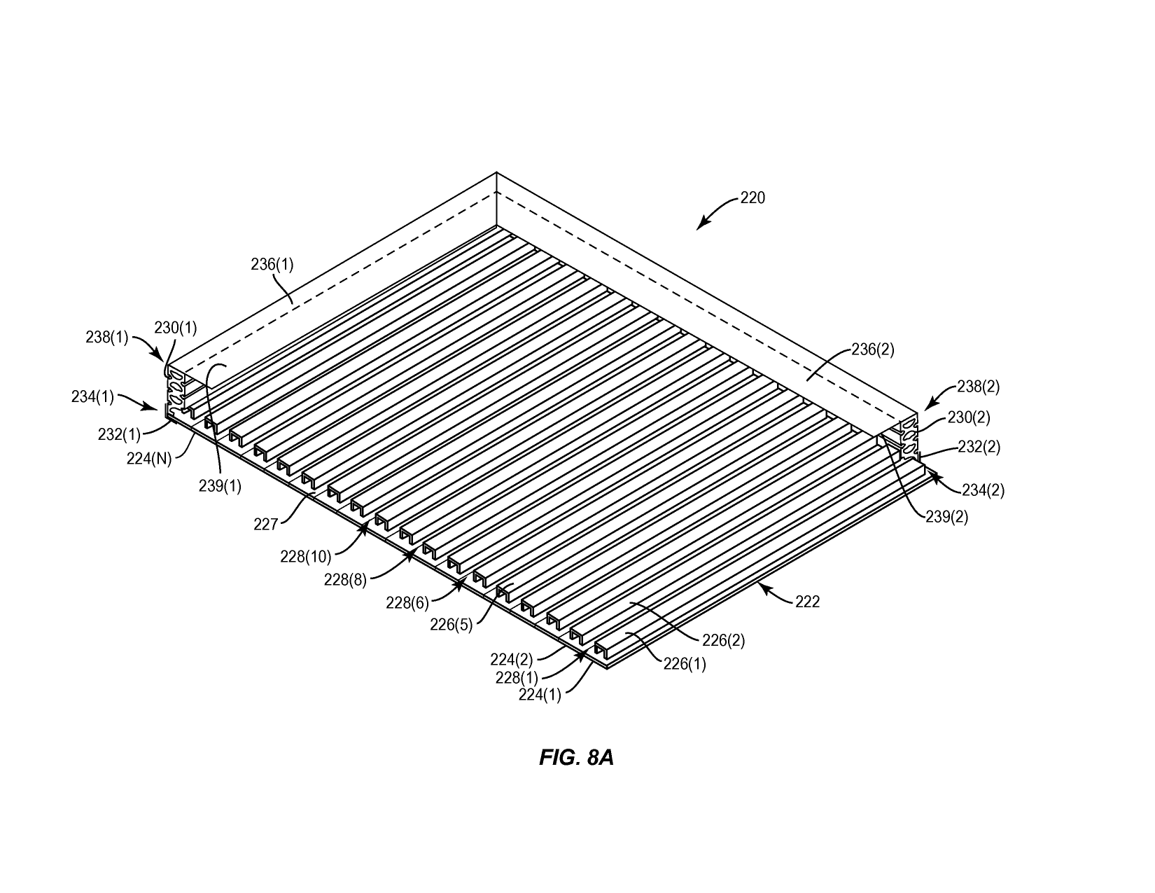

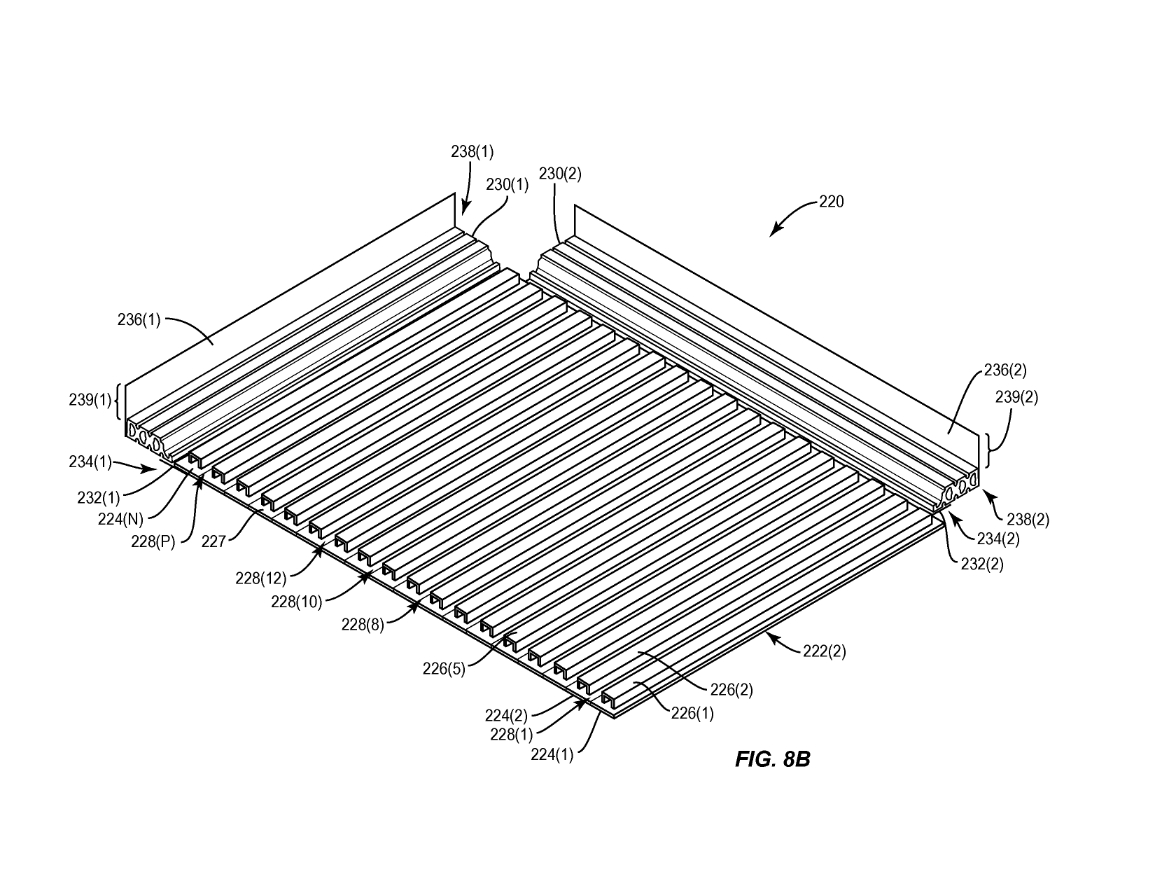

FIGS. 8A and 8B illustrate top perspective views of a mattress assembly 220 which is another embodiment of mattress assembly 72-3. In this embodiment, the mattress assembly 220 also includes cloth members or materials to secure side support members to a base that forms an encasement of the mattress assembly 220. The cloth members may also provided to secure the side support members to a core or innerspring disposed on the base in the mattress assembly 220.

In this regard, as illustrated in FIG. 8A, a base 222 may be provided in the mattress assembly 220. The base 222 may be a foam base and may be foamed from any of the materials described herein. In this embodiment, the base 222 may be comprised of a number of individual elongated foam members 224(1)-224(N) that are bonded or otherwise secured together laterally to form the base 222. The elongated foam members 224(1)-224(N) include at least one apexed elongated member 226(1)-226(N), respectively. By apexed elongated member 226, it is meant that a portion of the elongated foam member 224 is raised from a base or planar portion 227 of the elongated foam member 224 that can form channels between adjacent ones of the plurality of apexed elongated members 226. In this regard, channels 228(1)-228(P) are formed in the space left void by adjacent ones of the plurality of the apexed elongated members 226(1)-226(N) in the base 222. In this manner, coils or other core materials can be disposed in the channels 228(1)-228(P) to be stabilized and/or to be secured about or on the base 222.

With continuing reference to FIGS. 8A and 8B, side support members 230(1), 230(2) are also provided in the mattress assembly 220. The side support members 230(1), 230(2) may also be formed from a foamed material and thus be a foam side support member. The side support members 230(1), 230(2) are disposed perpendicular or substantially perpendicular to the base 222 to form an encasement for the mattress assembly 220 in assembled form. In this regard, at least one cloth member 232(1), 232(2), which may be a non-woven material or a woven material, is provided to secure the side support members 230(1), 230(2) to the base 222 at a first end 234(1), 234(2) of the side support members 230(1), 230(2), respectively, as illustrated in FIG. 8A. All of the previous discussion regarding at least one cloth member 80 or materials and using cloth materials to secure the foam side support member 78 to the foam base 76 are equally applicable for FIG. 8A and 8B and thus will not be repeated here.

With continuing reference to FIGS. 8A and 8B, an additional cloth material 236(1), 236(2) is also employed and secured to a second end 238(1), 238(2) of the side support members 230(1), 230(2), respectively. In this regard, when coils or springs or an innerspring or other core material is disposed on the base 222, overhang portions 239(1), 239(2) of the cloth materials 236(1), 236(2) can be disposed over a portion of the innerspring or the mattress core 74 and be secured to the innerspring or the mattress core 74 to stabilize and secure the side support members 230(1), 230(2) about the innerspring or core of the mattress assembly 220. The mattress assembly 220 in FIG. 8A may be particularly well suited for pocketed coils, wherein the overhang portions 239(1), 239(2) of the cloth materials 236(1), 236(2) can be secured to the pocket material of the pocketed coils disposed around the outside perimeter of the mattress assembly 220 adjacent to the side support members 230. As a non-limiting example, the cloth material 236(1), 236(2) may be eight (8) inches in width to provide the overhang portion 239 that extends beyond the top planar surface of the side support members 230, which may be three (3) inches in width.

FIG. 8B illustrates the mattress assembly 220 in FIG. 8A. However, in FIG. 8B, the side support members 230 are disposed in an unassembled form. The side support members 230(1), 230(2) are rotated and disposed downward about the hinge provided by the cloth material 232 between the side support members 230(1), 230(2) and the base 222 to be disposed planar or substantially planar of the elongated foam members 224(1)-224(N). In this regard, when an innerspring or the mattress core 74 is disposed on the elongated foam members 224(1)-224(N) during assembly, the side support members 230(1), 230(2) can thereafter be flipped upward in the configuration illustrated in FIG. 8A about the hinge provided by the cloth material 232 to be disposed perpendicular or substantially perpendicular to the plane of the elongated foam members 224(1)-224(N) to form an encasement for the mattress assembly 220.

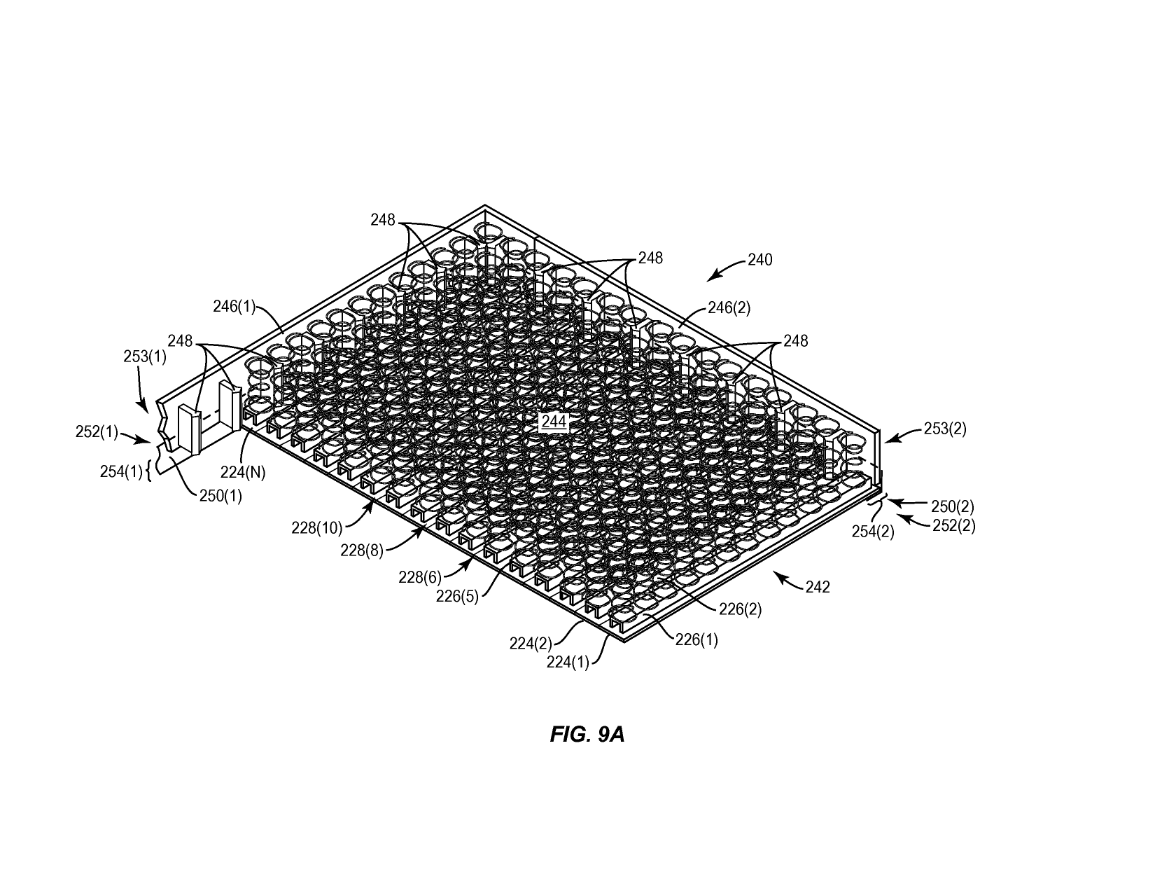

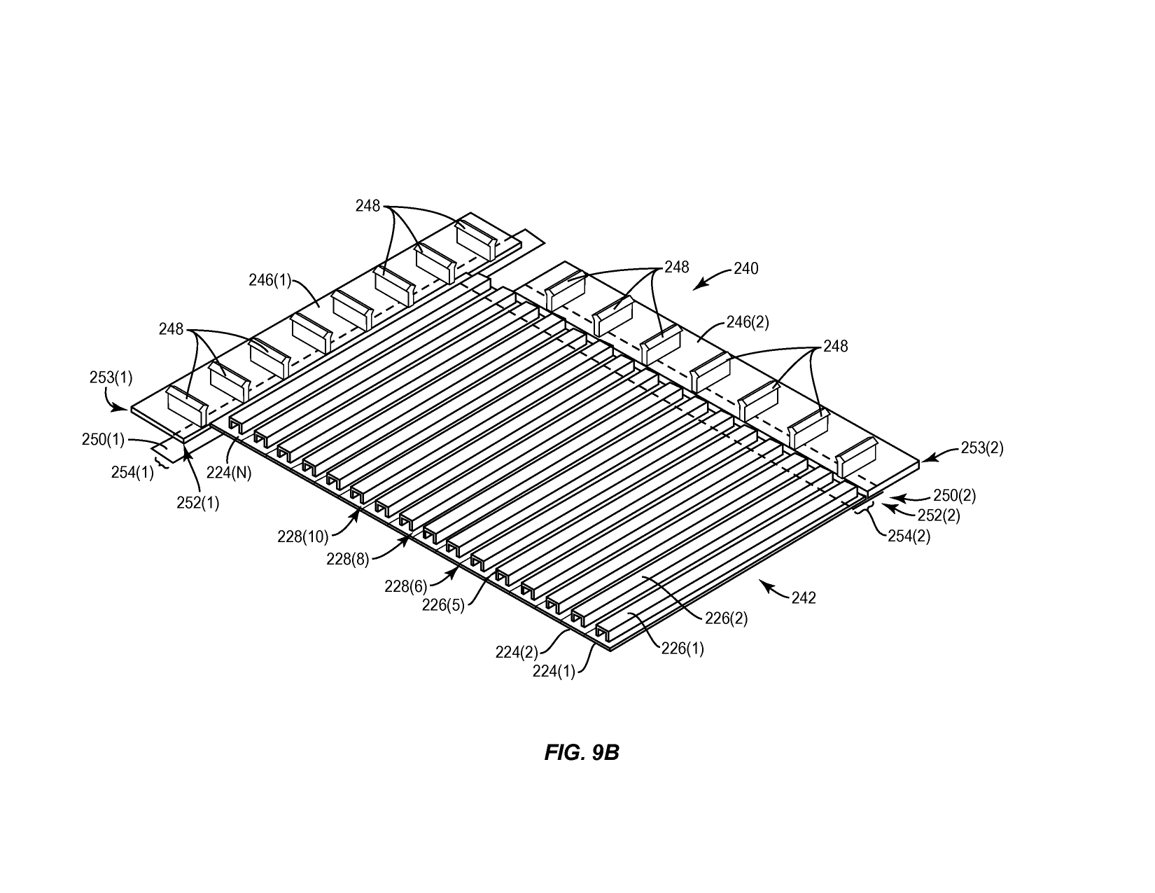

FIGS. 9A and 9B illustrate another exemplary mattress assembly 240 that can also employ cloth material to secure side support members to a base that forms an encasement for the mattress assembly 240. In this regard, the mattress assembly 240 includes a base 242, which may be a foam base, and a coil innerspring 244 disposed on the base 242. The coil innerspring 244 is disposed on the base 242.

With continuing reference to FIGS. 9A and 9B, in this embodiment, alternative side support members 246(1), 246(2) are employed to provide encasement around the coil innerspring 244 to form the mattress assembly 240. In this regard, the side support members 246(1), 246(2) are foam members that include protrusions 248 along its elongated length. The protrusions 248 disposed in the side support members 246(1), 246(2) are configured to be disposed between adjacent coil springs disposed on the outer perimeter of the coil innerspring 244 to secure the side support members 246(1), 246(2) about the coil innerspring 244. In this embodiment, this configuration eliminates the need to provide a cloth material, like the cloth material 236 in the mattress assembly 220 in FIGS. 8A and 8B, to secure the side support members 246(1), 246(2) to the coil innerspring 244. However, in this embodiment, at least one cloth material 250(1), 250(2) is provided to attach a first end 252(1) of the side support member 246(1) to the base 242. A second end 253(1), 253(2) of the side support 246(1), 246(2) may be opposite the first end 252(1), 252(2), respectively. In this regard, the cloth material 250 is provided secured to the first end 252 of the side support members 246(1), 246(2). An overlap portion 254(1), 254(2) of the cloth material 250(1), 250(2) may be disposed about the outer periphery of the base 242, securing the side support members 246(1), 246(2) to the base 242, which may be according to any of the previously described methods disclosed herein.

FIG. 9B illustrates the mattress assembly 240 in FIG. 9A. In FIG. 9B, the side support members 246 are disposed planar or generally planar to the base 242 about the hinge provided by the cloth material 250 during assembly. In this manner, after the coil innerspring 244 is disposed on the base 242, the side support members 246 can be flipped up about the hinge provided by the cloth material 250 to be disposed perpendicular or substantially perpendicular to the foam base 242 to provide the encasement around the coil innerspring 244 for the mattress assembly 240.

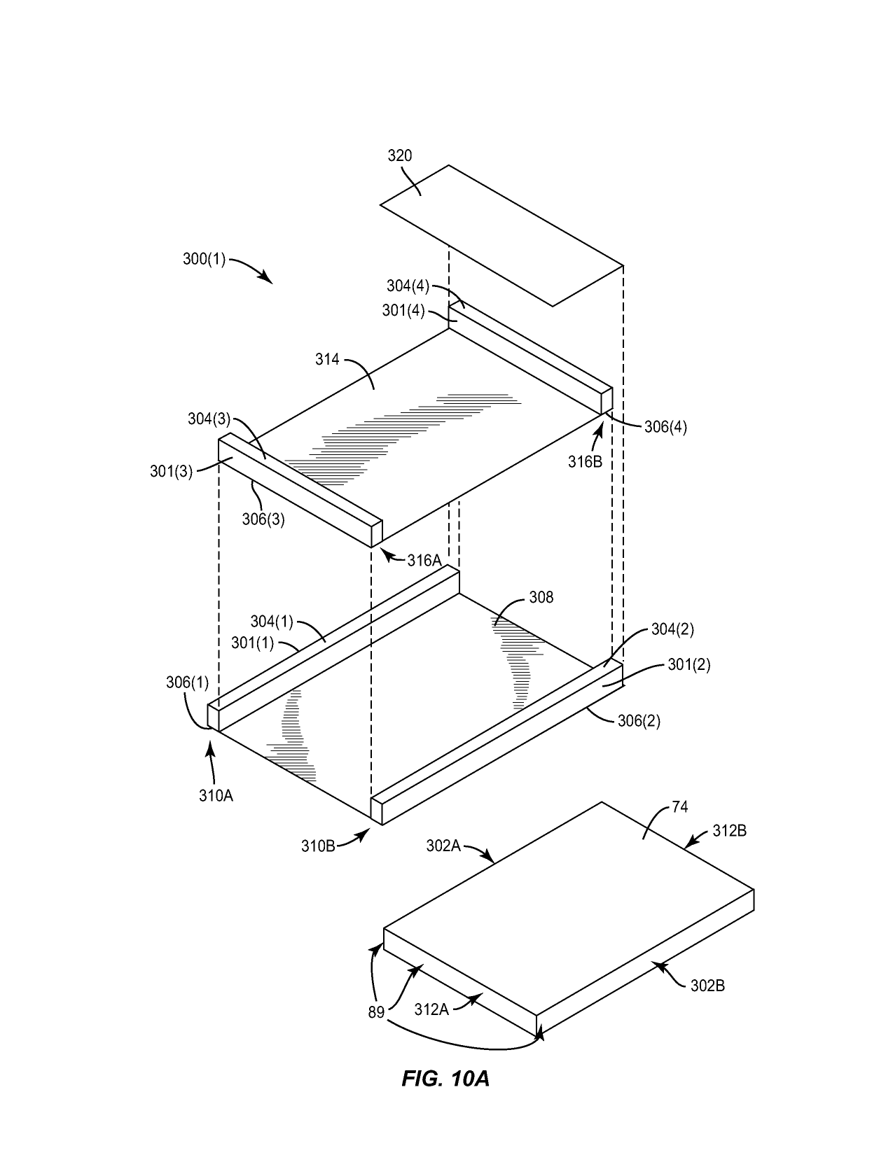

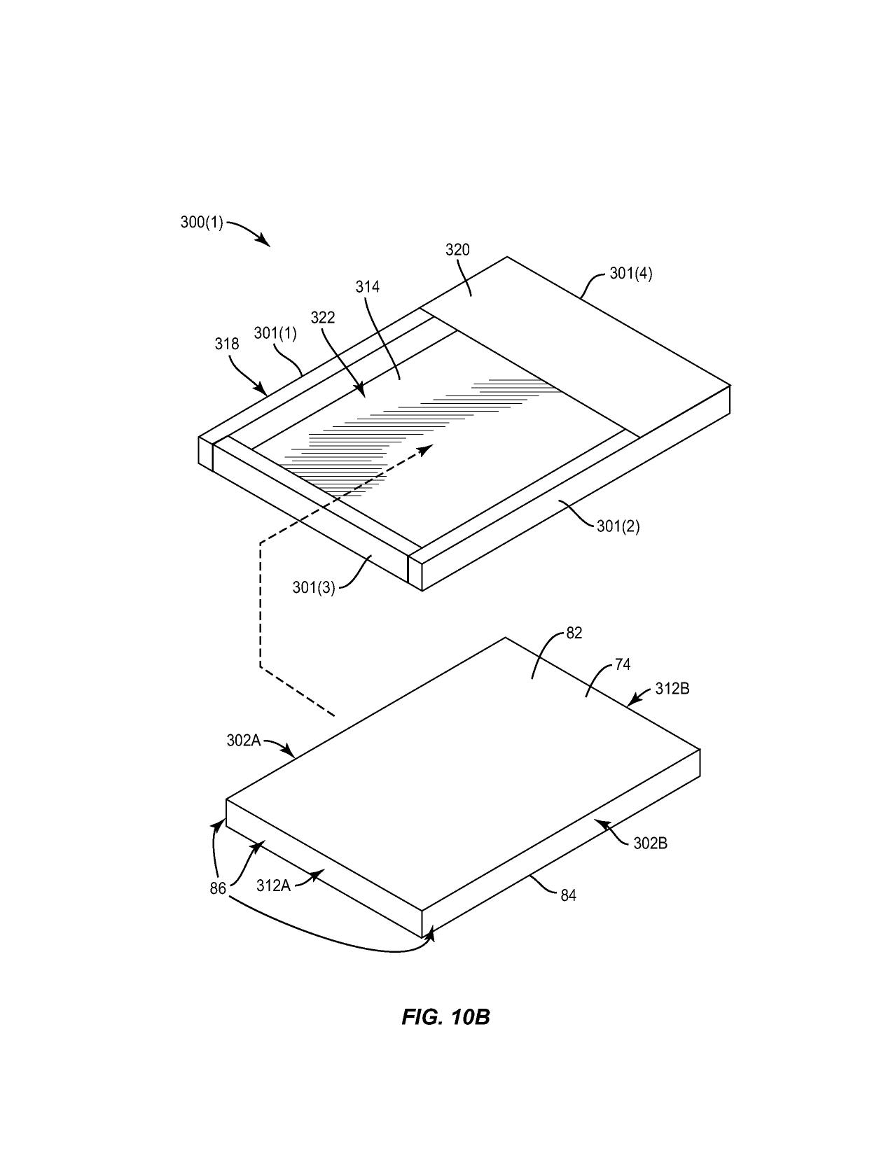

Other embodiments of the mattress assembly 72-3 are possible using at least one side support and at least one cloth member. FIGS. 10A and 10B are a top perspective exploded view and a top perspective view, respectively, of another embodiment of a mattress assembly 300(1). The mattress assembly 300(1) may include a pair of foam side support members 301(1), 301(2) including a first foam side support member 301(1) and a second foam side support member 301(2). The pair of foam side support members 301(1), 301(2) may be configured to be disposed adjacent the periphery portion 86 of the mattress core 74 and at opposite sides 302A, 302B of the mattress core 74 to provide side support for the mattress core 74. Each of the pair of foam side support members 301(1), 301(2) includes a first surface 304(1), 304(2) and a second surface 306(1), 306(2) opposite the first surface 304(1), 304(2), respectively.

The mattress assembly 300(1) may also include at least one cloth member 308 having a first end 310A thermally bonded to the first foam side support member 301(1) and having a second end 310B of the at least one cloth member 308 thermally bonded to the second foam side support member 301(2). In this manner, a position of the pair of the foam side support members 301(1), 301(2) may be restricted relative to each other.

The mattress assembly 300(1) may also include a second pair of foam side support members 301(3), 301(4) including a third foam side support member 301(3) and a fourth foam side support member 301(4). The second pair of foam side support members 301(3), 301(4) may be configured to be disposed adjacent the periphery portion 86 of the mattress core 74 and at opposite sides 312A, 312B of the mattress core 74 to provide side support for the mattress core 74. Each of the second pair of the foam side support members 301(3), 301(4) includes a first surface 304(3), 304(4) and a second surface 306(3), 306(4) opposite the first surface 304(3), 304(4), respectively.

With continued reference to FIGS. 10A and 10B, the mattress assembly 300(1) may also include at least one second cloth member 314 having a first end 316A thermally bonded to the third foam side support member 301(3) and a second end 316B thermally bonded to the fourth foam side support member 301(4). Collectively, the pair of foam side support members 301(1), 301(2) and the second pair of foam side support members 301(3), 301(4) may be configured to engage with each other to enclose the mattress core 74. The at least one cloth member 308 and the at least one second cloth member 314 may be configured to be disposed on the same side (in this case both facing the second support surface 84) of the mattress core 74.

The second pair of foam side support members 301(3), 301(4) may engage with the pair of foam side support members 301(1), 301(2) to surround the periphery portion 86 of the mattress core 74 thereby forming a periphery ring 318. The periphery ring 318 is a set of foam side support members comprising the foam side support members 301(1)-301(4) that fully surround the mattress core 74. In this manner, the mattress core 74 may be surrounded and thereby have full side support about the periphery portion 86.

The mattress assembly 300(1) may also optionally include at least a third cloth member 320 attached to the pair of foam side support members 301(1), 301(2) wherein the third cloth member 320 may be configured to form an insertion opening 322 with the periphery ring 318 to allow the mattress core 74 to be inserted (see FIG. 10B) into the mattress assembly 300(1) through the insertion opening 322. In this manner, the third cloth member 320 may assist in preventing the mattress core 74 from departing the periphery ring 318.

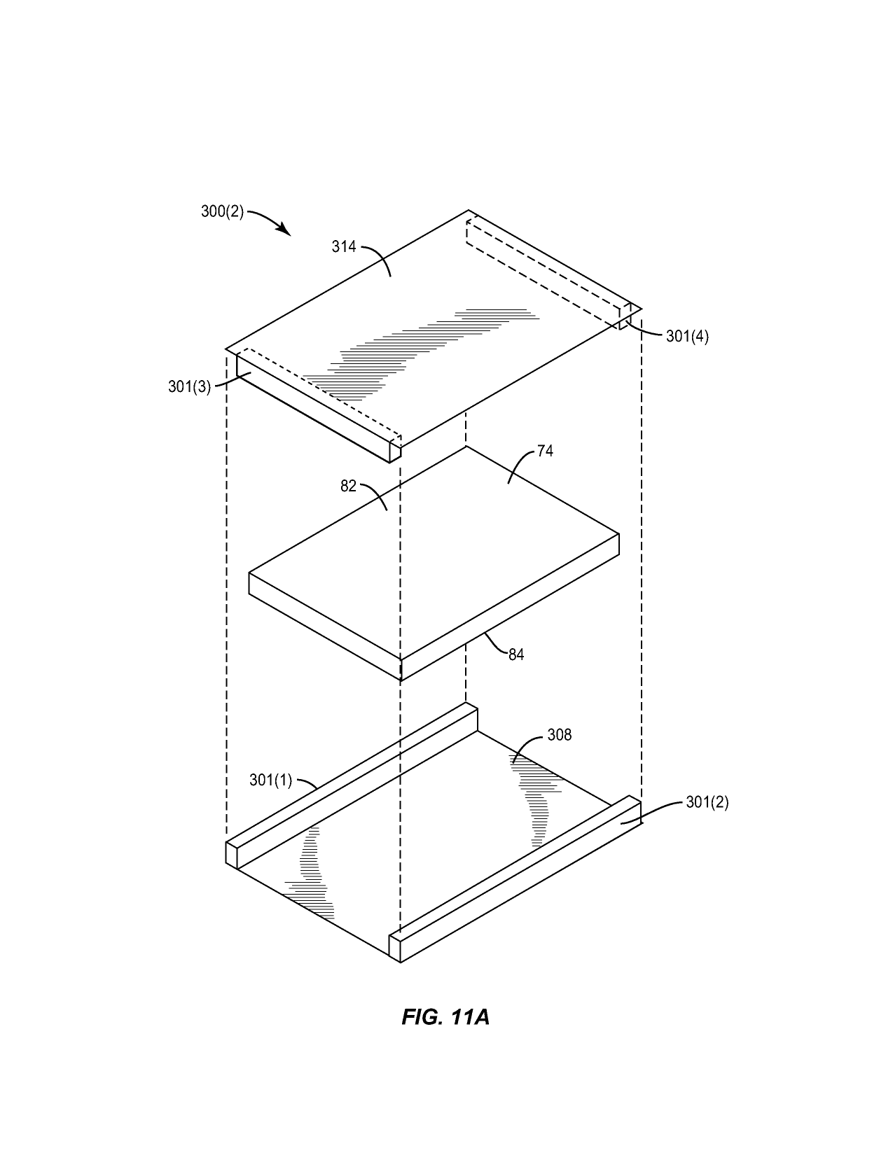

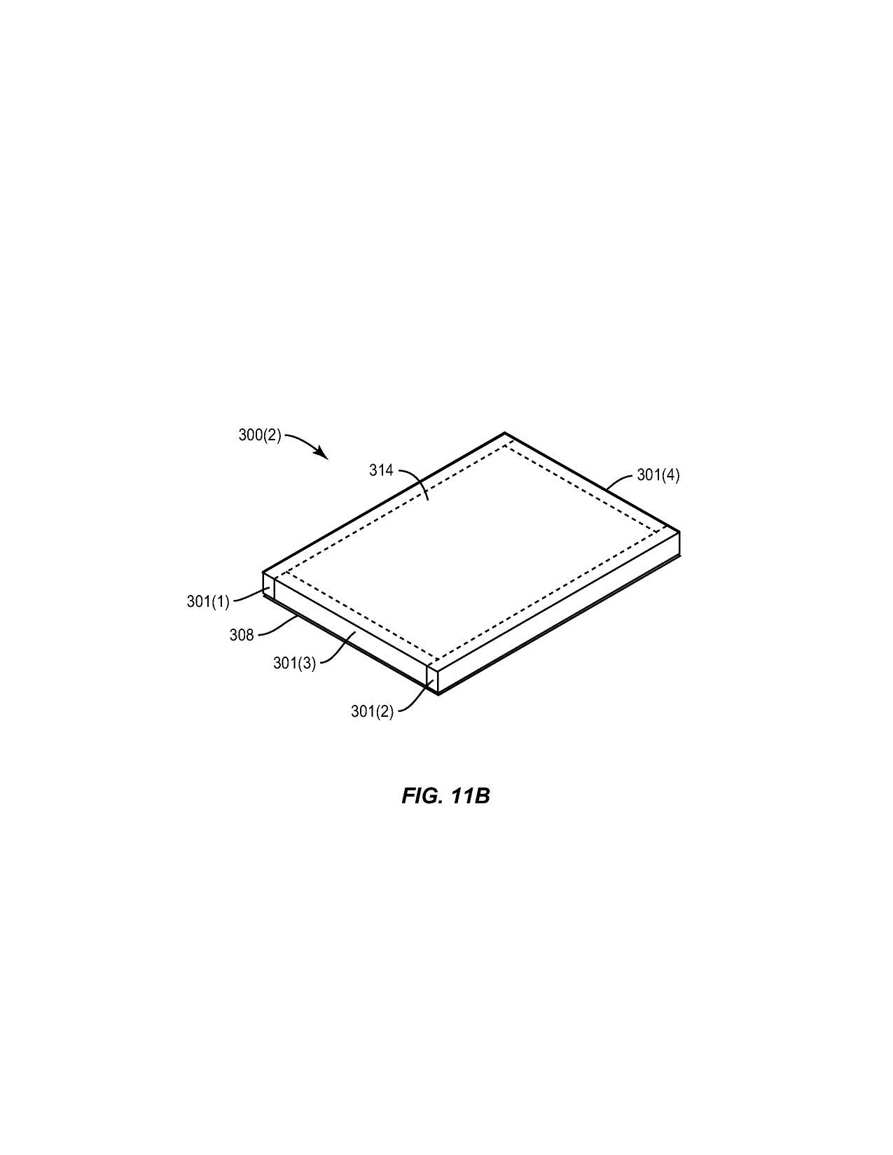

FIGS. 11A and 11B are a top perspective exploded view and a top perspective view, respectively, of another embodiment of a mattress assembly 300(2) which is similar to the mattress assembly 300(1) and so only the differences will be discussed to provide clarity and conciseness. Instead of including the third cloth member 320 to assist in preventing the mattress core 74 from departing the periphery ring 318, the mattress assembly 300(2) may be assembled so that the at least one cloth member 308 and the at least one second cloth member 314 are disposed on opposite sides (see FIG. 4D, the first support surface 82 and the second support surface 84) of the mattress core 74. In this manner, the mattress core 74 may be efficiently enclosed within the mattress assembly 300(2).

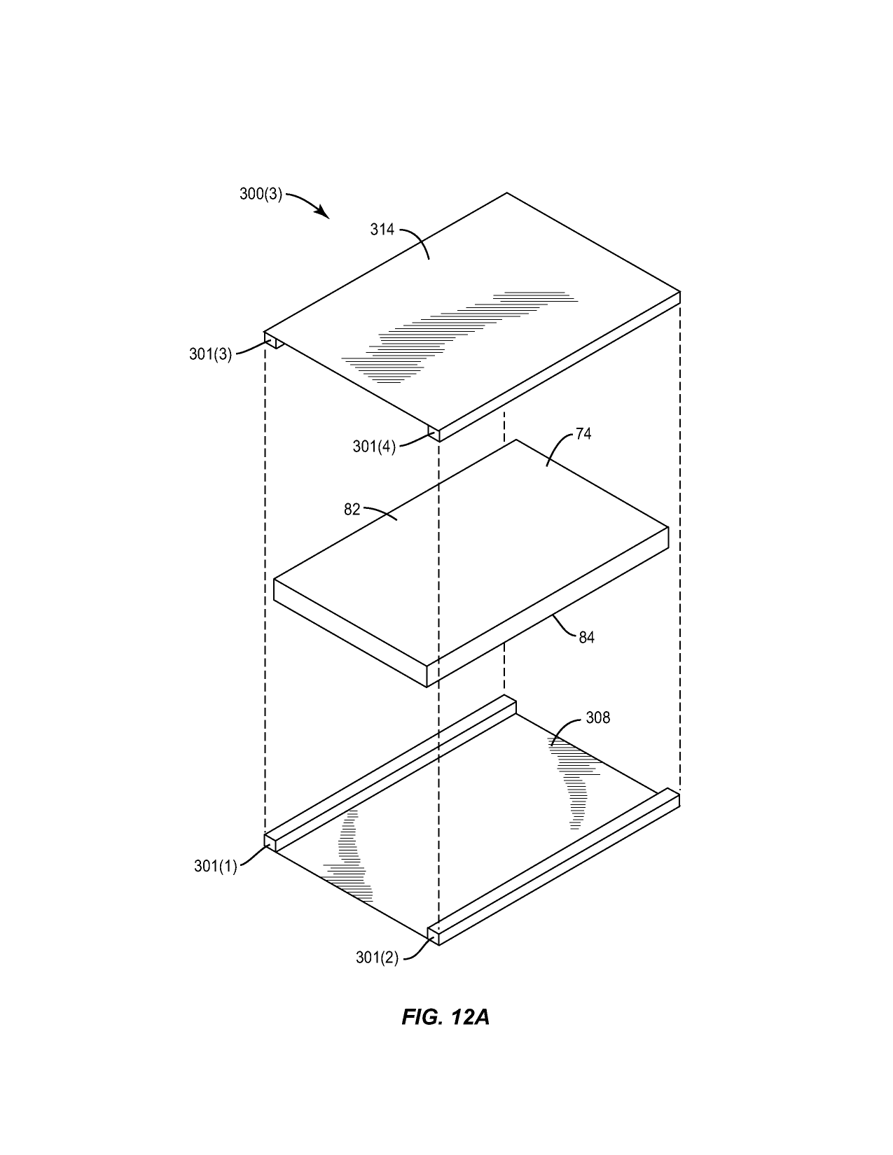

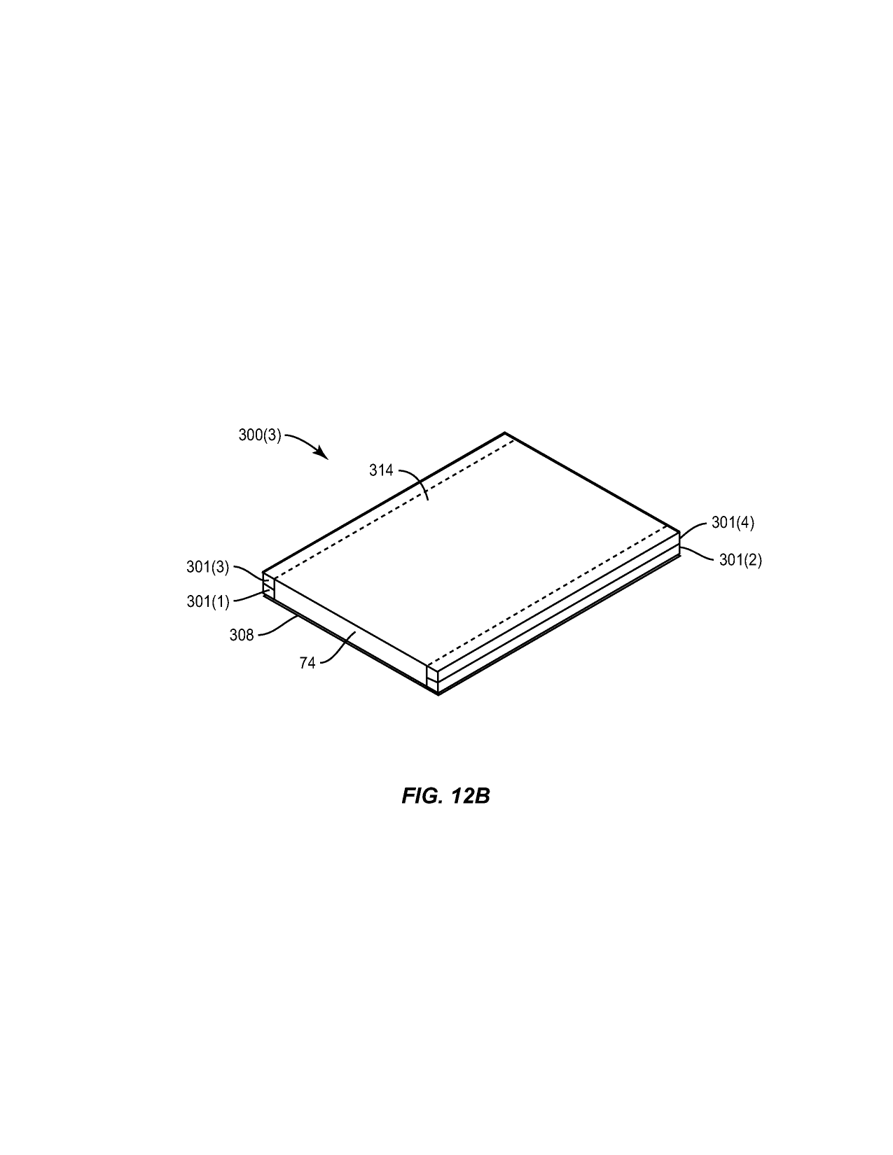

FIGS. 12A and 12B are a top perspective exploded view and a top perspective view, respectively, of another embodiment of a mattress assembly 300(3) which is similar to the mattress assembly 300(2) and so only the differences will be discussed to provide clarity and conciseness. Here, the second pair of foam side support members 301(3), 301(4) may be configured to abut (FIG. 12B) against the pair of foam side support members 301(1), 301(2) while parallel to form an enclosure for the mattress core 74. In this manner, each of the foam side support members 301(1)-301(4) may be smaller and easier to warehouse and transport than in the mattress assembly 300(2). It is noted that upholstery 38 (FIG. 2B) may be used to keep the second pair of foam side support members 301(3), 301(4) from separating from the pair of foam side support members 301(1), 301(2).

Instead of including the third cloth member 320 to assist in preventing the mattress core 74 from departing the periphery ring 318, the mattress assembly 300(2) may be assembled so that the at least one cloth member 308 and the at least one second cloth member 314 are disposed on opposite sides (see FIG. 4D, the first support surface 82 and the second support surface 84) of the mattress core 74. In this manner, the mattress core 74 may be efficiently enclosed within the mattress assembly 300(2) and precisely positioned relative to the foam side support members 301(1)-301(4).

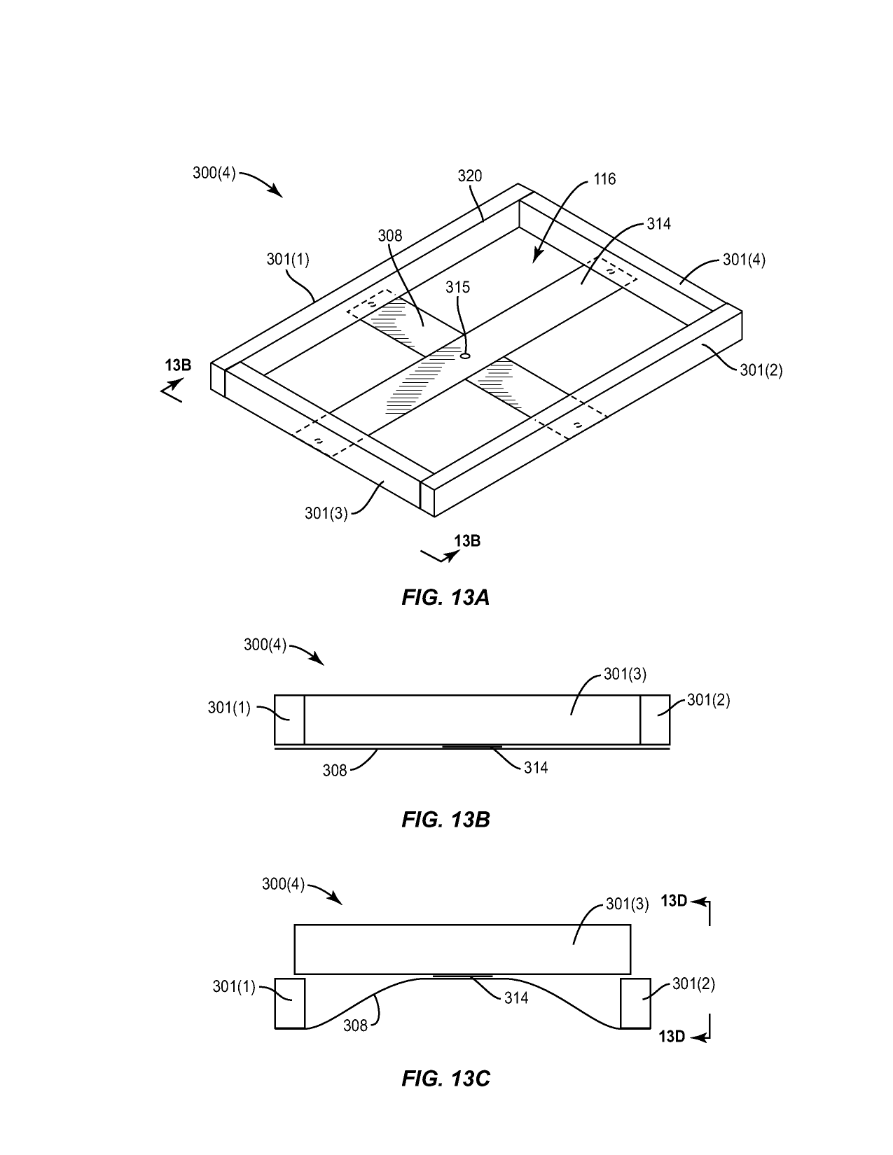

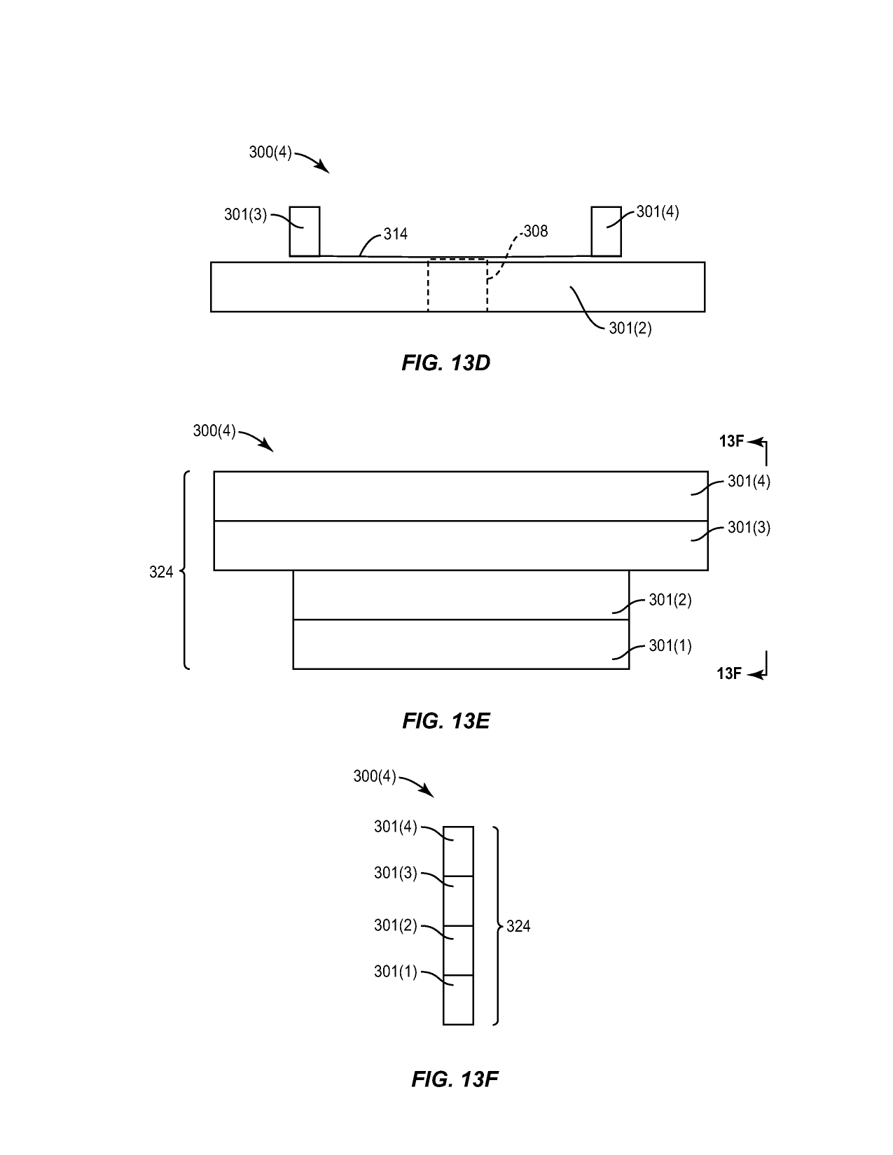

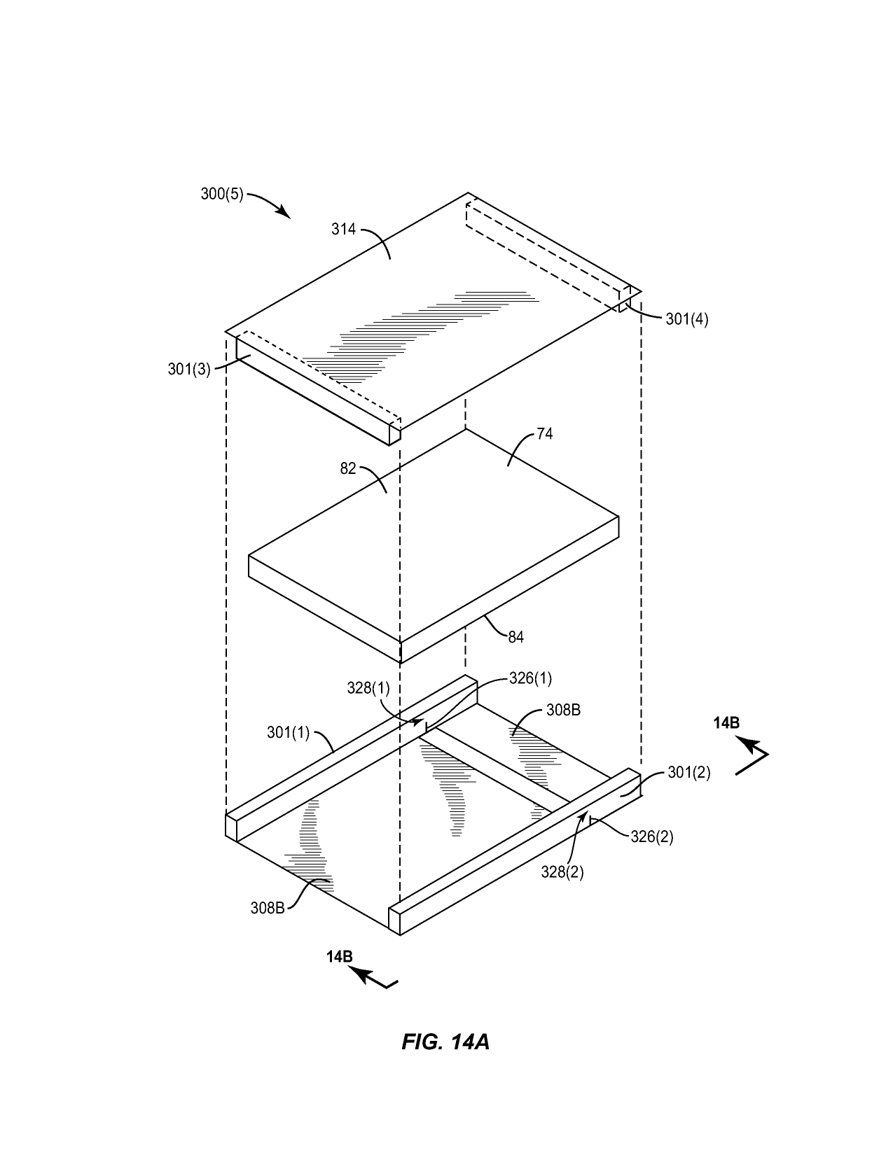

FIGS. 13A and 13B are a top perspective view and a side view, respectively, of another embodiment of a mattress assembly 300(4) with the pair of foam side support members 301(1), 301(2) attached to the at least one cloth member 308 and the second pair of foam side support members 301(3), 301(4) attached to at least one second cloth member 314. The second pair of foam side support members 301(3), 301(4) may be configured to be disposed between the pair of foam side support members 301(1), 301(2) to partially enclose the interior space 116. The interior space 116 may be configured to contain the mattress core 74. The at least one cloth member 308 and the at least one second cloth member 314 may be attached, for example, with a thermal bond or a fastener 315. FIGS. 13C through 13E are side views of the mattress assembly 300(4) of FIG. 13A where the pair of foam side support members 301(1), 301(2) and the second pair of foam side support members 301(3), 301(4) may be configured to be progressively disengaged to form an aligned stack 324. The aligned stack 324 may be a compact configuration relatively easy, for example, for warehousing or transporting. It is noted that the mattress core 74 is hidden in FIGS. 13A through 13F.

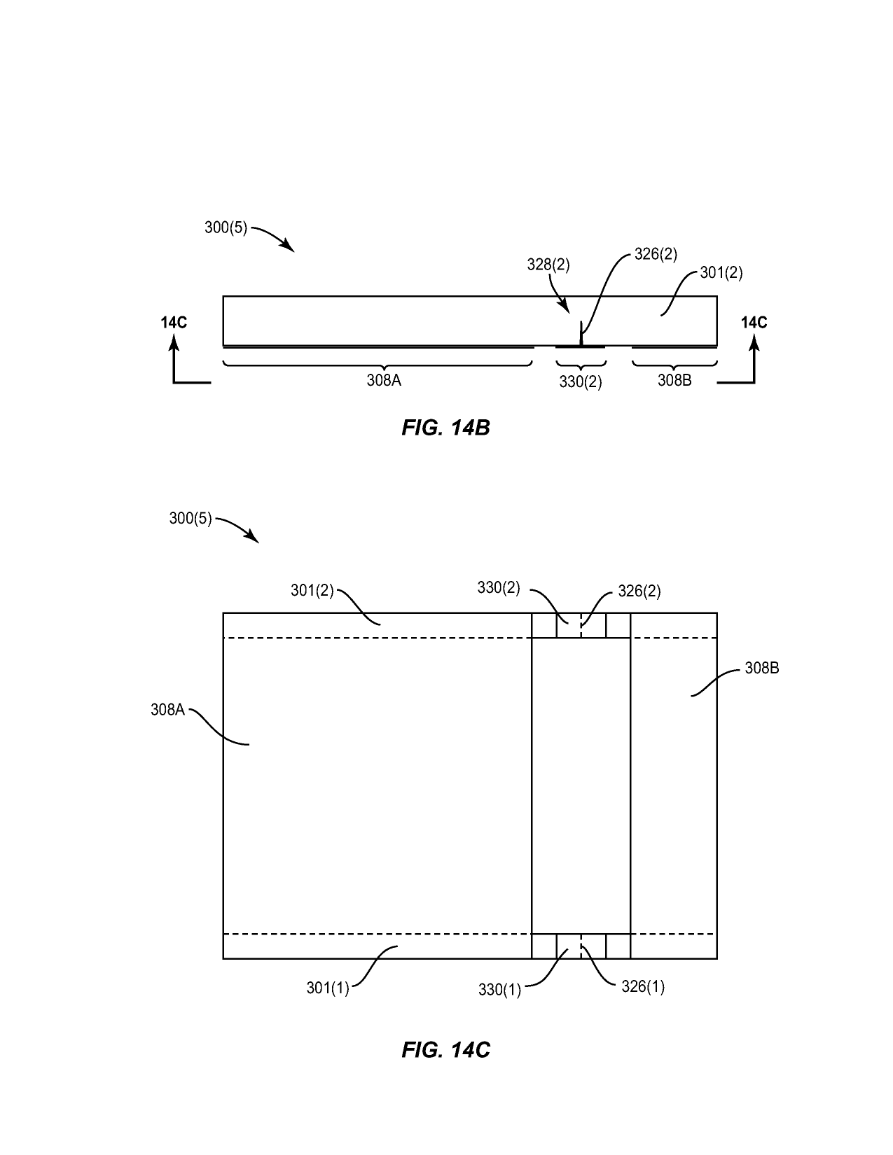

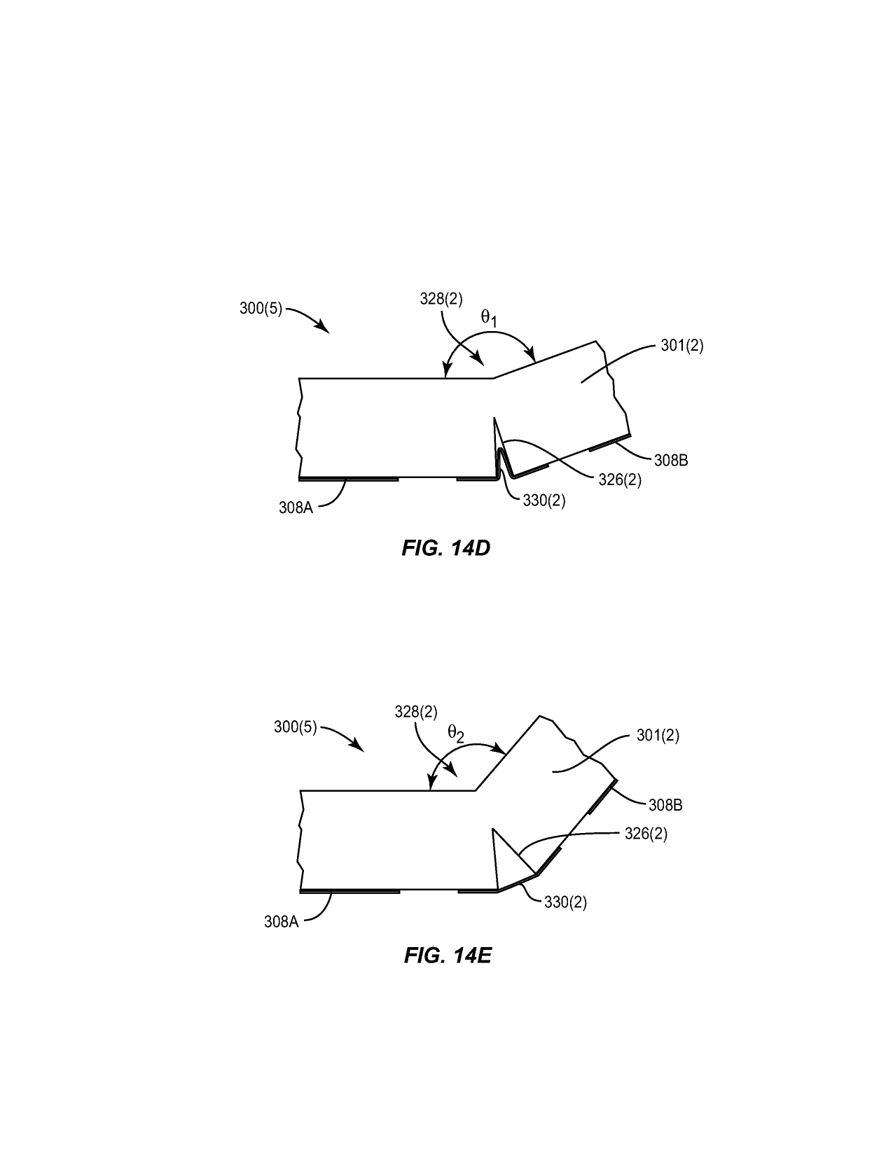

FIG. 14A through 14C are a top perspective exploded view, a side view, and a bottom view, respectively, of another embodiment of a mattress assembly 300(5) which is similar to the mattress assembly 300(2) (see FIG. 11A) and so only the differences will be discussed to provide clarity and conciseness. At least one difference may be that, in mattress assembly 300(5), the at least one foam side support member 301(1), 301(2) includes at least one partial cut 326(1), 326(2) through a cross-section to thereby form at least one living hinge 328(1), 328(2) configured to allow angular articulation. As shown in FIGS. 14D and 14E, the mattress assembly 300(5) may include at least another cloth member 330(1), 330(2) which may be thermally bonded to the at least one foam side support member 301(1), 301(2) and may be disposed across the at least one partial cut 326(1), 326(2), respectively, to restrict the angular articulation of the at least one living hinge 328(1), 328(2), for example, to an angle theta 2 (θ₂) in FIG. 14E which is greater than an angle theta 1 (θ₁) in FIG. 14D. It is noted that the at least one cloth member 308A, 308B may be attached to the at least one foam side support member 301(1), 301(2) at different sides of the at least one partial cut 326(1), 326(2) to allow the at least one partial cut 326(1), 326(2) to move. In this manner, the mattress assembly 300(5) may be compatible with angular articulation.

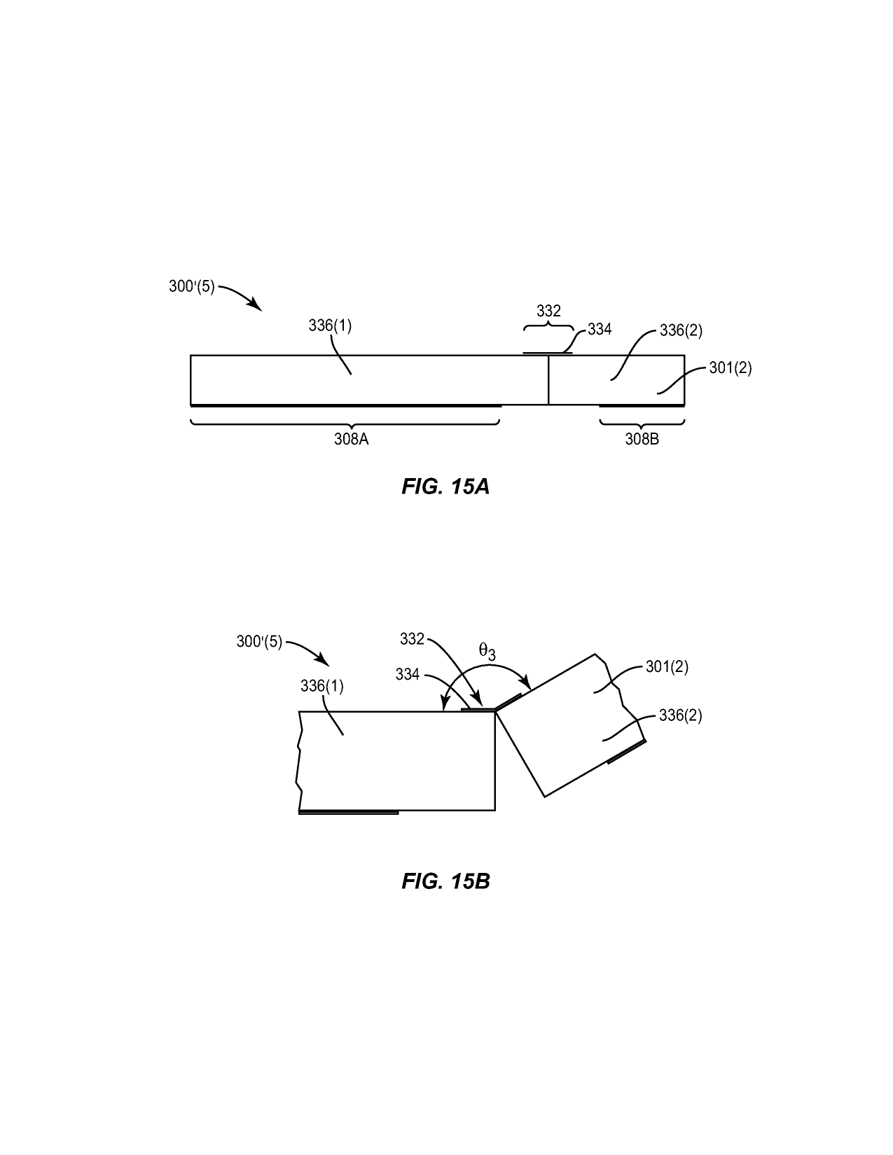

FIGS. 15A and 15B are a side view and a close-up side view, respectively, of another embodiment of a hinge 332 of the mattress assembly 300(5), designated as mattress assembly 300′(5), illustrating at least one another cloth member 334 attached to adjacent segments 336(1), 336(2) of the pair of foam side support members 301(1), 301(2) and the at least one another cloth member 334 being utilized as a pivot of the hinge 332. FIG. 15B depicts the hinge 332 with angular articulation to an angle theta 3 (θ₃). In this manner, a reliable alternative hinge may be formed for angular articulation.

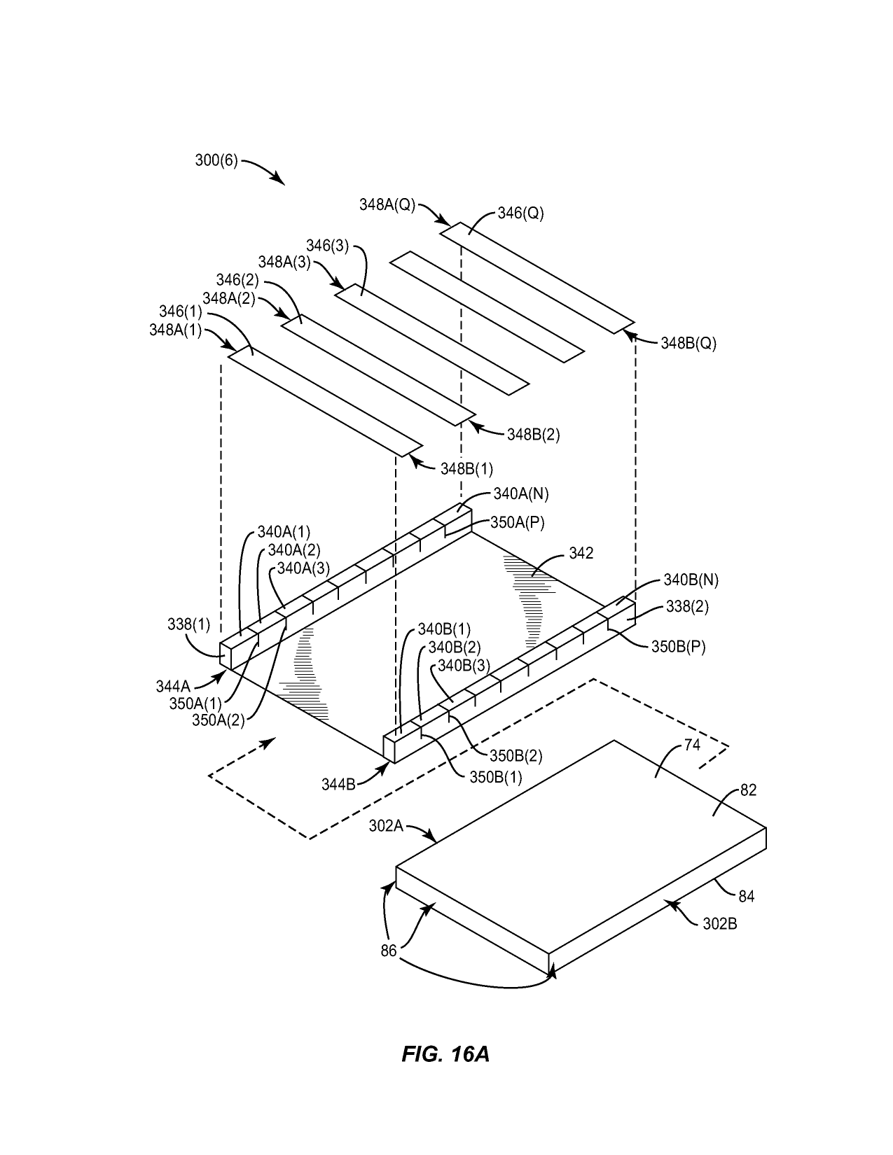

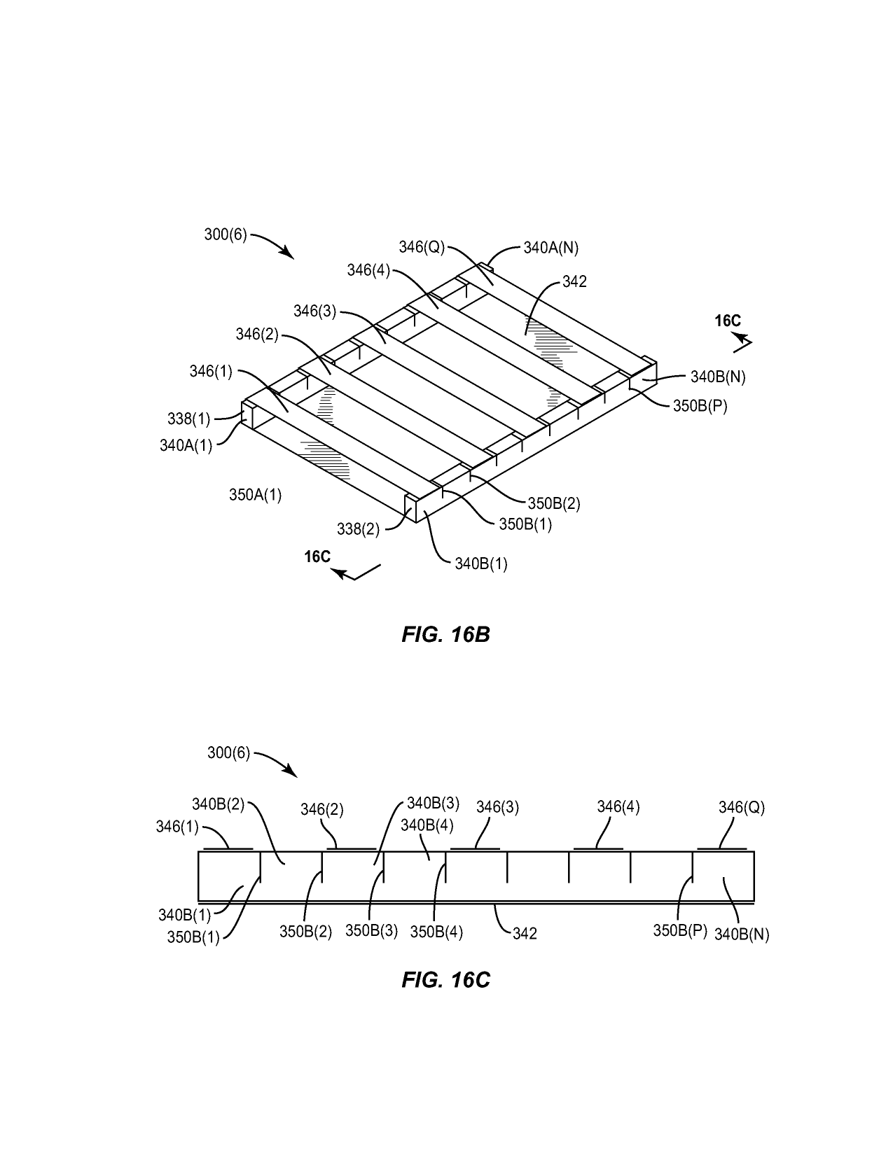

FIGS. 16A through 16C are a top perspective exploded view, a top perspective view, and a side view, respectively, of another embodiment of a mattress assembly 300(6). The mattress assembly 300(6) may include a pair of foam side support members 338(1), 338(2) including a first foam side support member 338(1) and a second foam side support member 338(2). The pair of foam side support members 338(1), 338(2) may be configured to be disposed adjacent the periphery portion 86 of the mattress core 74 and at opposite sides 302A, 302B of the mattress core 74 to provide side support for the mattress core 74. The first foam side support member 338(1) may comprise adjacent first segments 340A(1)-340A(N), and the second foam side support member 338(2) may comprise adjacent second segments 340B(1)-340B(N). The mattress assembly 300(6) may also include at least one cloth member 342 having a first end 344A thermally bonded to the first foam side support member 338(1) and having a second end 344B thermally bonded to the second foam side support member 338(2). The mattress assembly 300(6) may also include at least one second cloth member 346(1)-346(Q). Each of the at least one second cloth member 346(1)-346(Q) has a first end 348A(1)-348A(Q) thermally bonded to a respective one of the adjacent first segments 340A(1)-340A(N) of the first foam side support member 338(1) and has a second end 348B(1)-348B(Q) thermally bonded to a respective one of the adjacent second segments 340B(1)-340B(N) of the second foam side support member 338(2). The at least one cloth member 342 and the at least one second cloth member 346(1)-346(Q) may be configured to be on opposite sides of the mattress core 74, for example, see FIG. 4D regarding first support surface 82 and the second support surface 84. In this manner, the mattress core 74 may be better secured between the pair of foam side support members 338(1), 338(2).

In the mattress assembly 300(6), the first foam side support member 338(1) may comprise at least one first gap 350A(1)-350A(P) between the adjacent first segments 340A(1)-340A(N) and the second foam side support member 338(2) may comprise at least one second gap 350B(1)-350B(P) between the adjacent second segments 340B(1)-340B(N). The first gaps 350A(1)-350A(P) and the second gaps 350B(1)-350B(P) may be disposed at least half way through cross-sections of the first foam side support member 338(1) and the second foam side support member 338(2), respectively. The first gaps 350A(1)-350A(P) and the second gaps 350B(1)-350B(P) serve to prevent motion disturbance forces from traveling along the pair of foam side support members 338(1), 338(2). In this way, the adjacent first segments 340A(1)-340A(N) and the adjacent second segments 340B(1)-340B(N) of the mattress assembly 300(6) may be configured for motion isolation.

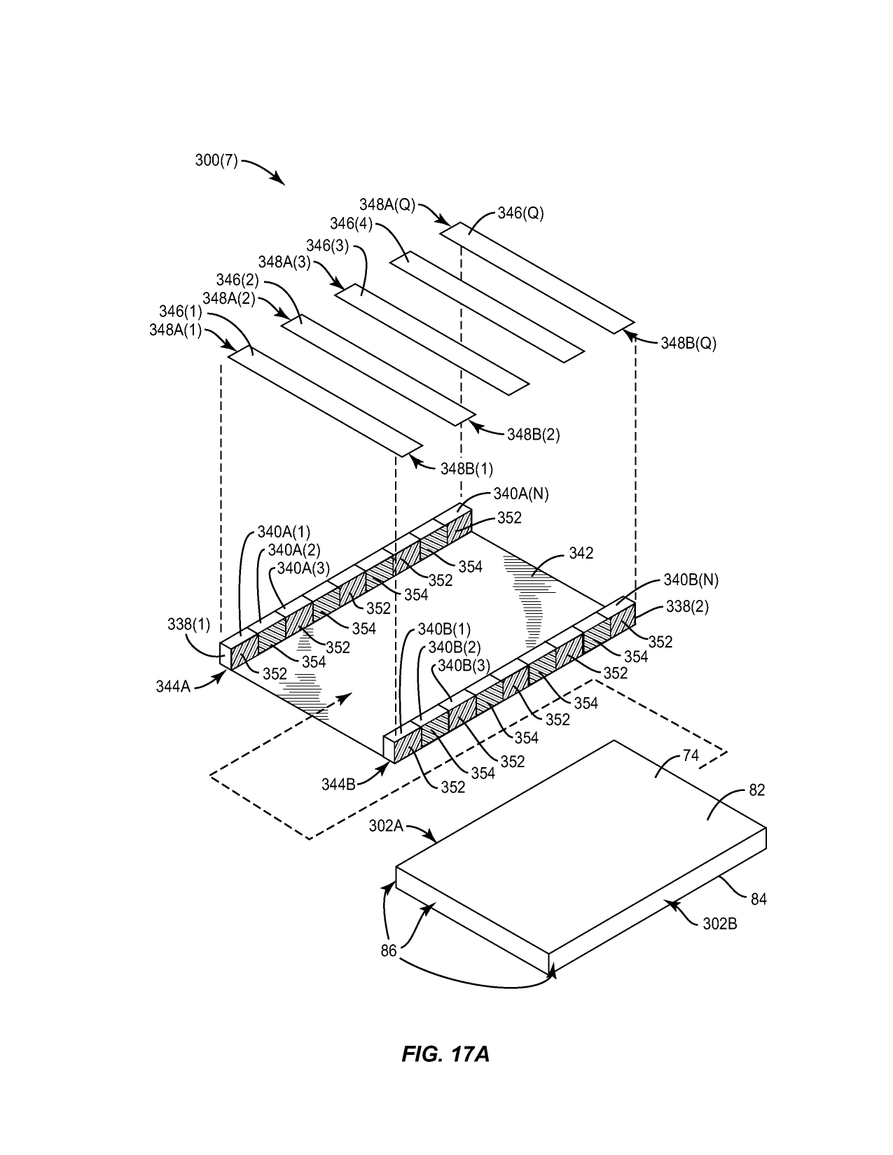

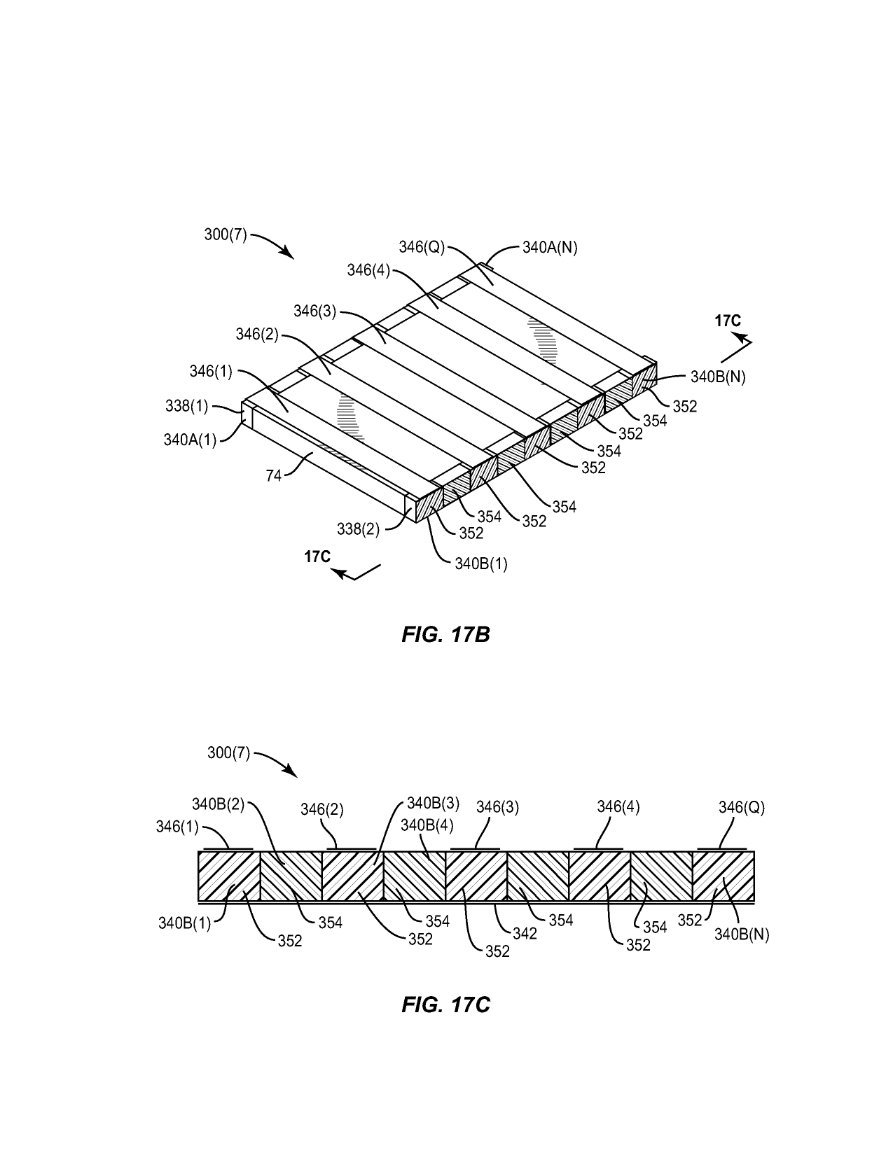

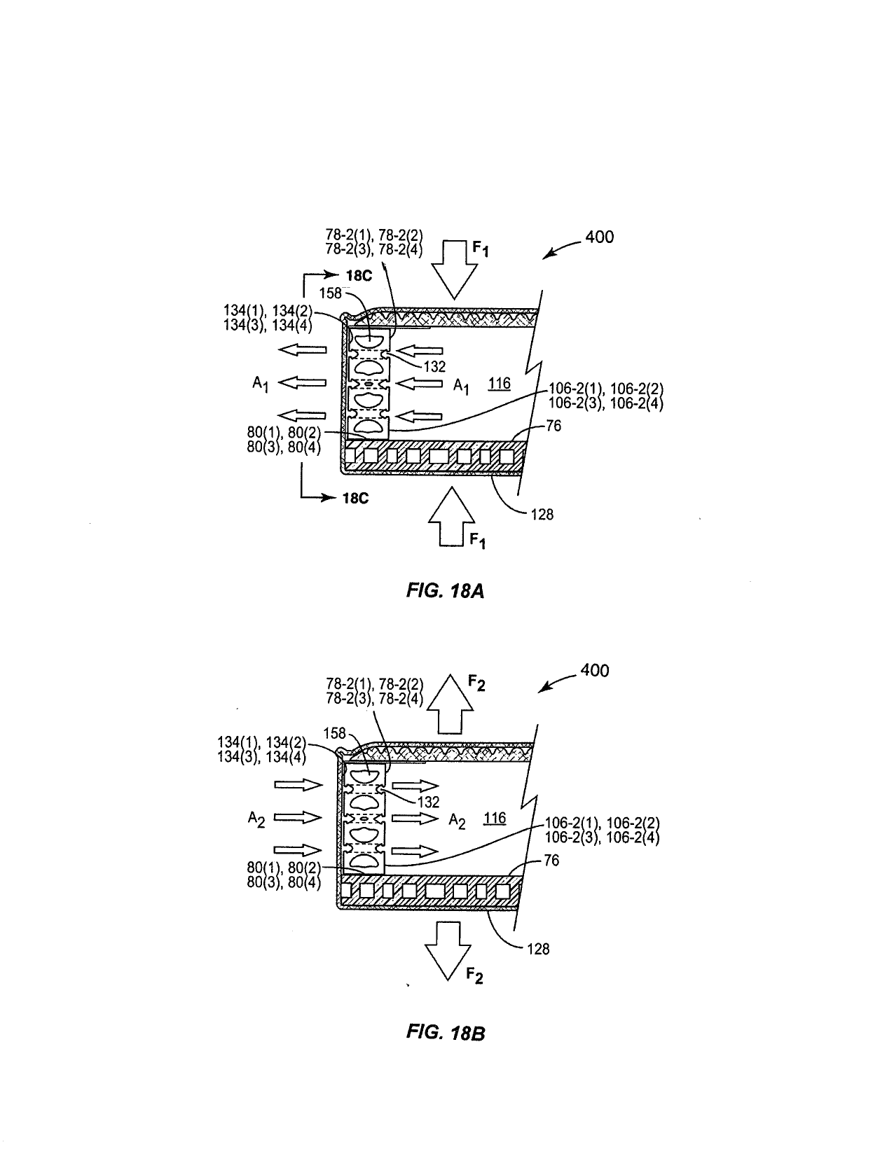

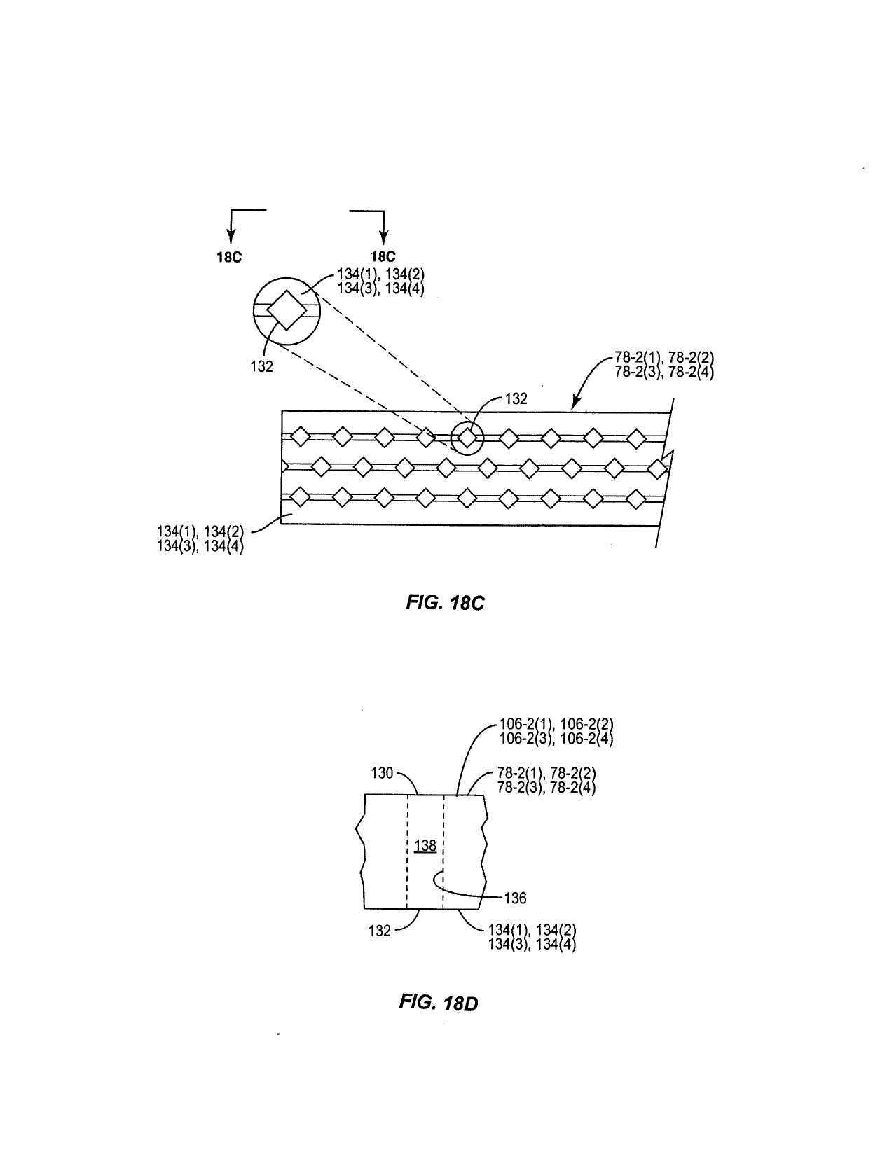

FIG. 17A through 17C are a top perspective exploded view, a top perspective view, and a side view, respectively, of another embodiment of a mattress assembly 300(7) which is similar to the mattress assembly 300(6) (see FIG. 16A) and so only the differences will be discussed to provide clarity and conciseness. The mattress assembly 300(7) may or may not include the first gaps 350A(1)-350A(P) and the second gaps 350B(1)-350B(P). At least one difference may be that in the mattress assembly 300(7), each of the adjacent first segments 340A(1)-340A(N) comprise different material compositions and each of the adjacent second segments 340B(1)-340B(N) comprise different material compositions having different energy absorption characteristics. In one preferred embodiment, one of the adjacent first segments 340A(1)-340A(N) comprises a thermoplastic material 352 and another of the adjacent first segments 340A(1)-340A(N) comprises a thermoset material 354. Further, one of the adjacent second segments 340B(1)-340B(N) comprises the thermoplastic material 352 and another of the adjacent second segments 340B(1)-340B(N) comprises the thermoset material 354. The different material compositions may be adjusted to allow some of the first segments 340A(1)-340A(N) and some of the second segments 340B(1)-340B(N) to absorb energy and thereby facilitate motion isolation.

Embodiments disclosed herein are exemplary, and may be provided together in any combination desired. Based on this disclosure, mattress assemblies may be assembled using the foam side support members 78(1)-78(4), 130, 146 disclosed herein around any of a variety of mattress cores, including for example, air bladder mattress cores, innerspring coil mattress cores, pocketed coil spring mattress cores (e.g., Marshall coil mattress cores), and mattress cores formed from a cellular material (e.g., foam). Because each elongated edge-support member disclosed herein is adaptable to be disposed around a variety of types and dimensions of mattress cores, the embodiments disclosed herein enable mattress core manufacturers to more easily store and transport the elongated edge-support members.

Those skilled in the art will recognize improvements and modifications to the embodiments disclosed herein. For example, the mattress assemblies 72-1-72-3, 220, 240 may have been discussed, for example, with a quantity of four (4) of the foam side support members 78(1)-78(4), 230(1)-230(2), 246(1)-246(2); the foam side support members 78-2(1)-78-2(4), 130, 146; the inner side surface 106(1)-106(4); the inner side surface 106-2(1)-106-2(4); the cloth members 80(1)-80(4), 136, 150; the outer side surface 134(1)-134(4); the peripheral portion 94(1)-94(4); a first surface 102(1)-102(4), the second surface 104(1)-104(4); the first attachment surface 96(1)- 96(4); the second attachment surface 98(1)-98(4); and the portion 92(1)-92(4). There may be the four (4), more than four (4), or less than four (4) of these items. Many modifications and other embodiments of the concepts set forth herein will come to mind to one skilled in the art to which the concepts pertain having benefit of the teachings presented in the foregoing descriptions and the associated drawings. The materials or compositions of the aforementioned components can be varied as well, including but not limited to whether foam may be exclusively thermoset or thermoplastic materials, or a composite of both. All such improvements and modifications are considered within the scope of the concepts disclosed herein.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art.

Further, it is to be understood that the embodiments are not limited to the specific embodiments disclosed and that modifications and other embodiments are intended to be included within the scope of the appended claims. It is intended that the embodiments cover the modifications and variations of this embodiment provided they come within the scope of the appended claims and their equivalents. Although specific terms are employed herein, they are used in a generic and descriptive sense only and not for purposes of limitation.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A mattress assembly, comprising:
a foam base having a top side and a bottom side, the foam base configured to support a mattress core disposed adjacent to the top side of the foam base;
at least one foam side support member configured to be disposed adjacent a periphery portion of the mattress core to provide side support for the mattress core supported by the foam base, the at least one foam side support member having a first surface facing away from the foam base and a second surface facing the foam base; and
at least one cloth member having a first side thermally bonded to a peripheral portion of the top side of the foam base and a second side thermally bonded to the second surface of the at least one foam side support member, to secure the at least one foam side support member with the periphery portion of the mattress core to form at least a portion of a mattress encasement.

2. The mattress assembly of claim 1, wherein the foam base is free from direct attachment with the at least one foam side support member.

3. The mattress assembly of claim 1, wherein the foam base is free from direct abutment with the at least one foam side support member.

4. The mattress assembly of claim 1, wherein the at least one cloth member comprises a first attachment surface and a second attachment surface opposite the first attachment surface, the first attachment surface attached to the at least one foam side support member, and the second attachment surface is attached to a portion of the foam base.

5. The mattress assembly of claim 1, wherein the at least one cloth member comprises nonwoven material including fibers.

6. The mattress assembly of claim 5, wherein the at least one cloth member comprises polyolefins.

7. The mattress assembly of claim 5, wherein the fibers comprise bicomponent fibers.

8. The mattress assembly of claim 5, wherein the fibers comprise at least 25 percent polyethylene.

9. The mattress assembly of claim 5, wherein the fibers comprise at least 25 percent polyethylene terephthalate.

10. The mattress assembly of claim 7, wherein the bicomponent fibers comprise polyethylene terephthalate and polyethylene.

11. The mattress assembly of claim 7, wherein the bicomponent fibers may further comprise at least one thermoplastic polymer comprised from the group consisting of polypropylene, polybutylene terephthalate, and polyamide.

12. The mattress assembly of claim 1, wherein the at least one foam side support member comprises a thermoplastic foamed material.

13. The mattress assembly of claim 1, wherein the at least one cloth member comprises woven material including fibers.

14. The mattress assembly of claim 1, wherein the at least one cloth member is attached to the foam base and the at least one foam side support member with an adhesive.

15. The mattress assembly of claim 1, wherein each of the at least one foam side support member further comprises an inner side surface configured to face the mattress core and an outer side surface opposite the inner side.

16. The mattress assembly of claim 15, wherein the second surface of the at least one foam side support member is attached to the at least one cloth member.

17. The mattress assembly of claim 15, wherein the inner side surface of the at least one foam side support member is configured to abut against the mattress core.

18. The mattress assembly of claim 15, wherein the at least one cloth member is thermally bonded to the inner side surface of the at least one foam side support member.

19. The mattress assembly of claim 1, further comprising a foam engagement member and a second cloth member, the second cloth member is thermally bonded to the foam engagement member and an inner side surface of the at least one foam side support member, wherein the foam engagement member forms a frictional fit or interference fit with the mattress core.

20. The mattress assembly of claim 16, further comprising a third cloth member configured to prevent the mattress core from departing from an interior space formed by the inner side surface of each of the at least one foam side support member and a portion of an inner base surface of the foam base, wherein the portion of the inner base surface faces the mattress core.

21. The mattress assembly of claim 20, wherein the interior space comprises an opening and the third cloth member is attached to the at least one foam side support member to at least partially close the opening to prevent the mattress core from departing the interior space.

22. The mattress assembly of claim 21, wherein the opening is opposite the portion of the inner base surface of the foam base.

23. The mattress assembly of claim 1, wherein the foam base is comprised of a plurality of apexed elongated members.

24. The mattress assembly of claim 23, further comprising a plurality of channels formed between adjacent apexed elongated members of the plurality of apexed elongated members.

25. The mattress assembly of claim 15, wherein the at least one cloth member is attached to the outer side surface of the at least one foam side support member and the foam base.

26. A mattress assembly to form a mattress encasement, comprising:
a pair of foam side support members comprising a first foam side support member and a second foam side support member, the pair of foam side support members configured to be disposed adjacent a periphery portion of the mattress core and at opposite sides of the mattress core to provide side support for the mattress core, each of the pair of the foam side support members having a first surface and a second surface opposite the first surface;
at least one cloth member having a first side thermally bonded to the first foam side support member and having a second side thermally bonded to the second foam side support member;
a second pair of foam side support members including a third foam side support member and a fourth foam side support member, the second pair of foam side support members is configured to be disposed adjacent the periphery portion of the mattress core and at opposite sides of the mattress core to provide side support for the mattress core, each of the second pair of the foam side support members having a first surface and a second surface opposite the first surface; and
at least one second cloth member having a first side thermally bonded to the third foam side support member and a second side of the at least one second cloth member thermally bonded to the fourth foam side support member,
wherein the pair of foam side support members and the second pair of foam side support members are collectively configured to engage with each other to enclose the mattress core.

27. The mattress assembly of claim 26, wherein the at least one cloth member and the at least one second cloth member are configured to be disposed on a same side of the mattress core.

28. The mattress assembly of claim 27, wherein the second pair of side support members engages with the pair of foam side support members to surround the periphery portion of the mattress core forming a periphery ring.

29. The mattress assembly of claim 28, further comprising at least a third cloth member attached to the pair of foam side support members wherein the third cloth member is configured to form an insertion opening with the periphery ring to allow the mattress core to be inserted into the mattress assembly through the insertion opening.

30. The mattress assembly of claim 26, wherein the at least one cloth member and the at least one second cloth member are disposed on opposite sides of the mattress core.

31. The mattress assembly of claim 30, wherein the second pair of foam side support members engages with the pair of foam side support members to surround the periphery portion of the mattress core forming a periphery ring.

32. The mattress assembly of claim 30, wherein the second pair of foam side support members is configured to abut against the pair of foam side support members while parallel to form an enclosure for the mattress core.

33. The mattress assembly of claim 28, wherein the at least one cloth member is attached to the at least one second cloth member.

34. The mattress assembly of claim 28, wherein the pair of foam side support members and the second pair of foam side support members are configured to be disengaged to form an aligned stack.

35. The mattress assembly of claim 26, wherein a cross-section of the at least one foam side support member includes at least one partial cut therethrough forming a living hinge configured to allow angular articulation.

36. The mattress assembly of claim 35, further comprising at least another cloth member which is thermally bonded to the at least one foam side support member and is disposed across the at least one partial cut to restrict the angular articulation of the living hinge.

37. The mattress assembly of claim 26, wherein a foam side support member of the pair of foam side support members comprises adjacent segments attached to at least another cloth member, wherein the at least another cloth member forms a hinge configured to allow angular articulation between the adjacent segments.

38. A mattress assembly to form a mattress encasement, comprising:
a pair of foam side support members comprising a first foam side support member and a second foam side support member, the pair of foam side support members configured to be disposed adjacent a periphery portion of a mattress core and at opposite sides of the mattress core to provide side support for the mattress core, the first foam side support member comprising adjacent first segments, the second foam side support member comprising adjacent second segments;
at least one cloth member having a first side thermally bonded to the first foam side support member and having a second side thermally bonded to the second foam side support member;
at least one segment-connecting cloth member, each of the at least one segment-connecting cloth member having a first side thermally bonded to a respective one of the adjacent first segments of the first foam side support member and having a second side thermally bonded to a respective one of the adjacent second segments of the second foam side support member, the at least one cloth member and the at least one segment-connecting cloth member are configured to be on opposite sides of the mattress core,
wherein the adjacent first segments and the adjacent second segments are configured for motion isolation.

39. The mattress assembly of claim 38, wherein the pair of first foam side support members comprises at least one first gap between the adjacent first segments and the second foam side support member comprises at least one second gap between the adjacent second segments.

40. The mattress assembly of claim 39, wherein the at least one first gap is disposed at least half way through a cross-section of the first foam side support member, and the at least one second gap is disposed at least half way through a cross-section of the second foam side support member.

41. The mattress assembly of claim 38, wherein each of the adjacent first segments comprise different material compositions and each of the adjacent second segments comprise different material compositions.

42. The mattress assembly of claim 38, wherein one of the adjacent first segments comprises thermoplastic material and another of the adjacent first segments comprises thermoset material, and
one of the adjacent second segments comprises thermoplastic material and another of the adjacent second segments comprises thermoset material.

43. A method of assembling a mattress encasement, comprising:
providing a foam base configured to support a weight of a user transmitted through a mattress core;
providing at least one foam side support member configured to be disposed along a periphery portion; and
providing at least one cloth member configured to be attached to the at least one foam side support member and the foam base.

44. The method of claim 43, further comprising attaching the at least one cloth member to a peripheral portion of the foam base and to the at least one foam side support member.

45. The method of claim 44, wherein the at least one foam side support member remains free of direct attachment to the foam base.

46. The method of claim 44, wherein the attaching the at least one cloth member includes attaching a first end of the at least one cloth member to the at least one foam side support member, and a second end of the at least one cloth member to the peripheral portion of the foam base, wherein the first end is opposite the second end.

47. The method of claim 43, wherein the at least one cloth member comprises fibers of a nonwoven material.

48. The method of claim 44, wherein the attaching the at least one cloth member further comprises attaching the at least one cloth member to the foam base and the at least one foam side support member with adhesive.

49. The method of claim 44, further comprising providing a mattress core comprising a first support surface configured to face the user applying the weight of the user to the mattress core, the mattress core includes a second support surface opposite the first support surface, and the mattress core includes a periphery portion connecting the first support surface with the second support surface;

50. The method of claim 49, further comprising inserting the mattress core into an interior space formed by an inner side surface of each of the at least one foam side support member and a portion of an inner base surface of the foam base, wherein the portion of the inner base surface faces the mattress core.

51. The method of claim 50, further comprising attaching another cloth member to the at least one foam side support member and the mattress core to prevent the mattress core from departing the interior space.

52. The method of claim 44, wherein the attaching the at least one cloth member further comprises attaching the at least one cloth member to the foam base and the at least one foam side support member by thermal bonding.

53. The method of claim 52, wherein the thermal bonding occurs through at least one manufacturing technique of the group consisting of: applying a hot plate to a thermal bond area, directing hot air to the thermal bond area, and directing ultrasonic energy to the thermal bond area.
